(19) United States
(12) Patent Application Publication
(10) Pub. No.: US 2021/0142241 A1
(43) Pub. Date: May 13, 2021

(54) Operations Management Methods and Products

(71) Applicant: Queen's University at Kingston, Kingston, CA (US)

(72) Inventors: Matthew Thompson, Sydenham (CA); Yuri Levin, Kingston (CA); Mikhail Nediak, Kingston (CA)

(21) Appl. No.: 16/491,950

(22) PCT Filed: Mar. 9, 2018
(86) PCT No.: PCT/CA2018/050281

§ 371 Date: Sep. 6, 2019

Related U.S. Application Data
(60) Provisional application No. 62/468,979, filed on Mar. 9, 2017.

(51) Int. Cl. G06Q 10/06; G06Q 10/08; G06Q 50/06

(52) U.S. Cl. CPC G06Q 10/0637; G06Q 10/0635; G06Q 50/06; G06Q 10/087; G06Q 10/0633

(57) ABSTRACT

Methods and products improve the profitability of a management strategy for a physical operation that converts a resource into a product or service, whereby a subset of relevant risk factors faced by the physical operation are traded in a financial derivatives market. A measure of at least one resource is obtained, and variables including the measure of the at least one resource are used to determine a first operating model and a second operating model. An operating strategy based on the first operating model is implemented in the physical operation and determines the way the resource is processed. Hedging strategies based on the first and second operating models and the measure of the at least one resource are used to develop a combined hedging strategy that is implemented in a financial market. The first operating model implemented in the physical operation together with the hedging strategy implemented in the financial market increase profitability of the physical operation.

### FIELD

The invention provides methods and products for improving the profitability of a management strategy for a physical operation that converts a resource into a product or service, whereby a subset of relevant risk factors faced by the physical operation are traded in a financial derivatives market.

### BACKGROUND

The existence of a liquid financial market for a firm's major inputs and outputs provides several benefits for operations managers. One benefit is that financial markets provide a mechanism for risk management which can be used to alter a firm's risk profile in a variety of helpful ways. Another benefit of financial derivatives markets is financial replication. Financial replication is a process whereby the cash-flows of any derivative payoff can be replicated using a specially chosen portfolio of the underlying tradeable risk factors. One application of financial replication forms the core concept of the theory of contingent-claims/real-options valuation.

When all of a firm's risk factors are spanned in the financial markets, the theory of real-options/contingent-claims valuation (CC) can be applied to determine unambiguous valuations for real physical assets. Whenever such physical assets have a degree of managerial flexibility that can be optimized, CC theory also provides a framework for making operations management (OM) decisions that will result in the highest possible current market valuation. CC methodologies utilize the principle of no-arbitrage. An example of an arbitrage would be if two different risk-free assets were found that had different rates of return. If this were ever to occur, an investor could short-sell the asset with the lower return, use the proceeds to purchase the asset with the higher return, and thereby make a risk-free profit with no actual investment. Such arbitrage opportunities should be extremely rare in a fair market, and hence the fair price for any risk-free asset should be the one that makes the return on this asset equal to that of a risk-free bond. The no-arbitrage concept has been extended to the pricing of risky assets such as an option whose value depends solely on some other underlying financial instrument(s). Key to this concept was the development of a specially designed options delta-hedging strategy for financial replication. An options delta-hedge is a trading strategy consisting of a dynamically varied quantity of the option's underlying(s), that is specifically chosen to synthetically replicate the change in value of a negative (short) position in the option. In other words, the delta-hedging strategy is chosen such that when a change in the value of the underlying causes the option value to rise/fall, the delta-hedge value falls/rises by the same amount. In this way the portfolio consisting of the option and its hedge becomes a risk-free asset. To avoid arbitrage, the fair market value of the option can then be determined by setting the return on this hedged portfolio equal to that of an equivalent risk-free bond. When CC theory is applied to real operational assets, the optimal operations management strategy is chosen to be the one that gives rise to the highest possible market value, as determined in this way.

One of the technical requirements that is needed for financial replication to work is that it is necessary to optimize and price the CC by assuming risk-neutrality and calculating the expected value of the pay-offs resulting from the optimal CC operating strategy, under the assumption that the expected value of the underlyings exactly matches the prices currently observed in the forward market. These facts imply that in complete markets, CC operating strategies are completely unambiguous and are the same for all managers who employ them regardless of their individual forecasts or risk preferences. When the goal is maximizing current market value, the CC assumptions are well established and justified. However, one aspect that current operations management theory and practice has yet to fully address is what happens when a hedging market exists for some of a firm's risk factors but management's risk preferences, discount rates, costs-of-capital, or price forecasts do not align with the CC pricing assumptions, and instead management prefers to incorporate their own views and expertise into their decision making. In such situations, it is currently not possible for operations managers to achieve these objectives without also damaging their market valuations.

### SUMMARY

To achieve the greatest possible operating/hedging outcomes for any operation in which a subset of the relevant risk factors are traded in the financial markets, at least two separate operating state models must be constructed for the same operation each representing the evolution of the operation under a different operating strategy. The first operating state model is used to develop an operating strategy designed to optimize the operation's evolution under the risk-neutral probability measure for tradeable risk-factors. A second operating state model is used to determine a ghost-operating and a ghost-hedging strategy. These strategies are designed to optimize the operation's evolution and risk management strategy, entirely under management's true-measure, risk-adjusted objective. Currently management implements a preferred ghost operating strategy directly in the real-world. In contrast, embodiments described here require that the operating strategy from the first operating model be implemented physically in the real-world operation. Thus a fundamental change in the real-world operation must take place. A contingent-claim on the payoffs of the ghost-operating strategy preferred by management is then determined using standard contingent claims theory. Improved profitability may then be achieved if management simultaneously implements the delta hedging strategy of the first model, the reverse-delta hedge of a hypothetical contingent-claim on the ghost-operating strategy found with the second model, along with the ghost-hedging strategy. A general framework is provided, with examples of implementations in various physical operations. According to the embodiments, when some or all of a firm's risk factors are traded in complete financial markets, utility maximization is achieved using the described combination of hedging strategies together with the aforementioned implementation in the physical operations. The framework presented here for implementing such operating/trading strategies in complex operations management problems is general enough to incorporate non-lognormal probability models, forward curves with arbitrary inter/intra-curve correlation structures, and stochastic volatilities.

As noted above, a benefit of financial derivatives markets is financial replication. According to the embodiments, a new application of financial replication is developed, that when combined with specific changes in a physical operation, will produce an increase in profitability relative to current practice.

In general, the methods described herein allow managers the flexibility to achieve objectives in a more profitable way as compared to what is currently possible.

Thus, according to one aspect of the invention there is provided a method for improving an operating strategy of a physical operation, comprising: obtaining a measure of at least one physical state variable that is produced, consumed, and/or processed by the physical operation; using the measure of at least one physical state variable to determine first and second operating models for the physical operation; implementing the first operating model in the physical operation such that the first operating model determines one or more of production, consumption, and processing of the physical state variable; deriving a tool from the first and second operating models comprising a financial hedging strategy that is implemented in a financial market; wherein the first operating model implemented in the physical operation together with the hedging strategy implemented in the financial market increase profitability of the physical operation.

According to another aspect of the invention there is provided a method of optimizing an operations management strategy, comprising: obtaining a measure of at least one physical state variable that affects a market value of an asset; using variables including the measure of at least one physical state variable to determine a first operating model that maximizes a current market value of the asset, and implementing an operating strategy based on the first operating model in a physical operation; deriving a delta hedging strategy based on the first operating model; using variables including the measure of at least one physical state variable to determine a second operating model comprising a ghost-operating strategy, and a ghost-hedging strategy; deriving a reverse delta-hedging strategy for a hypothetical contingent claim on the payoffs of the ghost-operating strategy using standard options pricing techniques; combining the delta hedging strategy, the ghost hedging strategy, and the reverse delta-hedging strategy to provide a combined hedging strategy; wherein the combined hedging strategy is executed financially (e.g., in a derivatives market).

According to another aspect there is provided a method for optimizing a management strategy for a physical operation, comprising: obtaining a measure of at least one physical state variable that affects a market value of an asset; using variables including the measure of at least one physical state variable to determine a first operating model that maximizes a current market value of the asset; implementing an operating strategy based on the first operating model in the physical operation; deriving a delta hedging strategy based on the first operating model; using variables including the measure of at least one physical state variable to determine a second operating model comprising a ghost operating strategy, and a ghost hedging strategy; deriving a reverse delta-hedging strategy corresponding to a hypothetical contingent claim on the payoffs of the ghost operating strategy; combining the delta hedging strategy, the ghost hedging strategy, and the reverse delta-hedging strategy to provide a combined hedging strategy; wherein implementing the operating strategy based on the first operating model in the physical operation determines a management strategy of the at least one physical state variable; wherein the combined hedging strategy is executed in a derivatives market.

In one embodiment, the first operating model includes forecasting asset value using a financial forward curve and using risk-free discount rates to adjust for risk and the time-value-of-money.

In one embodiment, the delta hedging strategy is derived from the first operating model under a risk-neutral probability measure or a partial risk-neutral probability measure covering tradeable risks.

In one embodiment, the second operating model is optimized under a preferred objective/utility function including a true probability measure that incorporates forecasts for all risk factors.

In one embodiment, the reverse-delta hedging strategy corresponds to a contingent-claim on payoffs of the second operating model.

In one embodiment, the reverse-delta hedging strategy synthetically replicates the changes in market value of a long position in a hypothetical contingent claim on the payoffs of the ghost-operating strategy determined using the second operating model.

In one embodiment, the combined physical operating and financial hedging strategies results in a higher managerial expected utility relative to what management could have achieved according to current practice.

Embodiments of the method may be applied to a physical operation comprising commodity extraction. The commodity extraction may be an industry selected from mining, forestry, oil, and gas. The physical state variable may comprise an amount of a resource that remains to be extracted.

Embodiments of the method may be applied to a physical operation comprising commodity storage. In one embodiment the physical state variable may comprise inventory level.

Embodiments of the method may be applied to a physical operation comprising electrical power generation. The physical state variable may be selected from boiler temperature and time since a unit was activated/de-activated.

Embodiments of the method may be applied to a physical operation comprising shipping and transportation. The physical state variable may comprise a location of a vessel or vehicle.

In various embodiments, the physical operating strategy, the reverse-delta hedging strategy, the hedging strategy, and the delta hedging strategy may be implemented according to sections 1.3, 1.4 or 1.5 described herein.

In various embodiments, the combined hedging strategy that is implemented includes a structured contingent claim leasing contract as described in subsections 3.2.3, 3.2.4, 3.2.5, and 3.2.6.

According to another aspect of the invention there is provided a non-transitory computer-readable medium for optimizing an operations management strategy, comprising instructions stored thereon, that when executed on a processor, perform one or more steps of any of the embodiments described herein.

According to another aspect of the invention there is provided a non-transitory computer-readable medium for optimizing an operations management strategy, comprising instructions stored thereon, that when executed on a processor, perform one or more of: receiving a measure of at least one physical state variable that is produced, consumed, and/or processed by the physical operation; using the measure of at least one physical state variable to determine first and second operating models for the physical operation; deriving a tool from the first and second operating models comprising a financial hedging strategy that is implemented in a financial market; wherein the first operating model implemented in the physical operation together with the hedging strategy implemented in the financial market increase profitability of the physical operation.

According to another aspect of the invention there is provided non-transitory computer-readable medium for optimizing an operations management strategy, comprising instructions stored thereon, that when executed on a processor, perform one or more of: receiving a measure of at least one physical state variable that affects a market value of an asset; using variables including the measure of at least one physical state variable to determine a first operating model that maximizes a current market value of the asset; outputting an operating strategy based on the first operating model in the physical operation; deriving a delta hedging strategy based on the first operating model; using variables including the measure of at least one physical state variable to determine a second operating model comprising a ghost operating strategy, and a ghost hedging strategy; deriving a reverse delta-hedging strategy corresponding to a hypothetical contingent claim on the payoffs of the ghost operating strategy; combining the delta hedging strategy, the ghost hedging strategy, and the reverse delta-hedging strategy to output a combined hedging strategy.

In one embodiment, the non-transitory computer-readable medium is applied to an operations management strategy for a physical operation comprising commodity extraction. In one embodiment, the commodity extraction is an industry selected from mining forestry, oil, and gas. In one embodiment, the physical state variable comprises an amount of a resource that remains to be extracted.

In one embodiment, the non-transitory computer-readable medium is applied to an operations management strategy for a physical operation comprising commodity storage. In one embodiment, the physical state variable comprises inventory level.

In one embodiment, the non-transitory computer-readable medium is applied to an operations management strategy for a physical operation comprising electrical power generation. In one embodiment, the physical state variable is selected from boiler temperature and time since a unit was activated/de-activated.

In one embodiment, the non-transitory computer-readable medium is applied to an operations management strategy for a physical operation comprising shipping and transportation. In one embodiment, the physical state variable comprises a location of a vessel or vehicle.

### BRIEF DESCRIPTION OF THE DRAWINGS

Embodiments of the invention will be described, by way of example, with reference to the accompanying drawings, wherein:

FIG. 1 is a block diagram of a generalized embodiment.

FIG. 2 is a plot showing an operation's optimal gold production schedule as given by prior optimization software according to proprietary inputs, as described in Example I.

FIG. 3 is a plot showing historical average annual cost for leasing gold.

FIG. 4 is a plot showing an operation's production plan for gold determined by prior software, resulting from market-based inputs (forward curves and discount rates), as described in Example I.

FIG. 5 is a plot showing an operation's original gold production plan (solid), and a production plan determined according to an embodiment (striped) as described in Example I.

FIG. 6 is a plot showing a ghost path operating (GPO) physical (solid) and financial (striped) plan, determined according to an embodiment as described in Example I.

FIG. 7 is a diagram of a four-port network for vessel routing as described in Example II.

FIG. 8 is a plot showing instantaneous volatility a as function of promptness of forward freight rates of four Baltic shipping routes, as described in Example II.

FIG. 9 is a plot showing correlation among different shipping routes and contracts of different promptnesses.

FIG. 10 is a plot showing realized profit of a standard approach versus the equivalent ghost-path enhanced approach as a function of cost, as described in Example II.

FIG. 11 is a plot showing percent improvement of ghost-path enhanced profit versus standard OM, as described in Example II.

FIG. 12 is a grade tonnage histogram for the Detour Lake Gold Mine, as described in Example III.

FIG. 13 is plot showing risk-free discount factors, as described in Example III.

FIG. 14 is a plot showing historical annual net convenience yields (lease rates) for gold, as described in Example III.

FIG. 15 is a plot showing production plan outputs for a 0.5 g/t cut-off strategy (management's preferred value implemented as an imaginary-option) and a 0.3 g/t cut-off strategy (real-options value that should be implemented physically), as described in Example III.

### DESCRIPTION

### Definitions

As used herein, the term “physical operation” refers to a process or industry that manages a resource, produces a commodity and/or converts resources into goods and services. Examples include, but are not limited to, mining, forestry, energy production (oil, gas, wind, solar, etc.), storage, and shipping and transportation.

As used herein, the term “physical state variable” refers to a quantity, such as an amount of a resource or commodity used by or produced by a physical operation. For example, in mining a physical state variable may be ore, gold, copper, etc.; in forestry a physical state variable may be standing timber, harvested timber, lumber, pulp, etc.; in shipping a physical state variable may be number of shipping vessels or vehicles and their sizes and locations, fuel, etc.

As used herein, the term “delta hedging strategy” refers to a portfolio of financial contracts that is designed to reduce or eliminate any aspect or component of risk from a given real or financial asset. Such a portfolio may either be fixed at the beginning or may be dynamically varied in time in response to fluctuations in one or more variables such as, but not limited to, price, cost, and rate.

A classic example of a delta hedging strategy was developed in the work of Black and Scholes (1973). In this reference a financial strategy consisting of a dynamically varied quantity of stock was developed to completely eliminate the financial risk associated with an option on that stock.

A more germane example might apply to a gold mining company that plans to produce thousands of ounces of gold in one year's time and is exposed to the risk that the price of gold in one year is unknown today and will fluctuate with supply/demand. A delta-hedging strategy for such a mine might be to short 1,000 ounces worth of gold futures on an exchange or through a bilateral agreement off the exchange, at a price that was agreed upon today. In this way regardless of whatever the price of gold happens to be in one year, the futures/forward contract would guarantee that the mine could sell their gold for the price that was agreed upon.

Another way a mine could achieve the same result is through the use of a gold lease agreement. For example, assume that a gold mining firm could borrow gold from gold owners/investors on a fully collateralized basis for 0.5% per year and assume that today's gold price is $1,500 and the mine wants to delta hedge 1000 ounces of production in one year. To achieve this objective the mine could borrow 1000/(1+0.005)≈995 ounces of gold today and sell this gold for 995×1500=$1,492,500. (To ensure full collateralization the mine may also have to issue royalty claims in the amount of 1000 ounces to the gold lender and be able to prove that they had said ounces.) Then in one year's time the mine would have to repay the gold loan plus the gold interest which would amount to 1000 ounces of gold, exactly the amount they are going to produce anyway and exactly the amount they wished to hedge. In this way the mine knows for sure that they will achieve revenue of $1,492,500 upfront. Both this delta hedging example and the previous one that used gold futures/forward contracts achieve the same delta hedging objective (reduction of financial risk). The only difference is in the former example the mine was paid in the future, whereas in the latter example the mine received the money upfront.

Yet another example may be a firm that knows they have to pay labour costs in one year's time in dollars. While the amount of dollars they have to pay may be known today, what might not be known is the buying power of a dollar in one year's time, which depends on the unknown rate of future inflation. To delta hedge this inflation risk, the firm could purchase inflation protected bonds with a face value equal to the amount of the future liability. Such inflation protected bonds pay their face value plus the amount of inflation as calculated by the central bank. Similar examples can be given for fuel cost risk, exchange rate risk, etc.

Sometimes a firm's operations may be more complicated and may require other kinds of hedging products. For example a commodity producer with the option to vary output levels in response to price fluctuations subject to certain constraints may be able to delta hedge their operation by selling a swing option (see Eydeland and Wolyniec 2003) with similar constraints to that of their own operation. An oil/gas storage company may be able to sell gas/oil storage contracts with injection/withdrawal characteristics mimicking those of their own operation (see Eydeland and Wolyniec 2003). Similarly an electrical power plant can delta hedge their operation by selling tolling contracts (see Eydeland and Wolyniec 2003) with ramp-rate restrictions and other constraints that match those of their own operation.

As used herein, the term “reverse delta hedging strategy” refers to a hedging strategy that is the opposite of a delta hedging strategy. For example, if a delta hedging strategy required selling 1,000 ounces of gold in the futures market, its reverse delta hedging strategy would be to buy 1,000 ounces of gold in the futures market. If a delta hedging strategy required that one borrow 995 ounces of gold today, its reverse delta hedging strategy would be to lend 995 ounces of gold today. If a delta hedging strategy meant selling a tolling contract, its reverse delta hedge would be to buy a tolling contract, etc.

As used herein, the term “market-based forward curves” refers to a set of prices, rates, etc. that can be used to implement a delta hedging strategy either on an exchange or using bilateral agreements. The curves may include a series of different prices corresponding to different future time periods. For example, the price of gold for each month trades on a futures exchange. The price for each month may be different, and represented as a curve. Similar concepts apply to interest rate, foreign exchange, counter-party credit risk, oil/gas, commodity risk, etc. A market-based forward curve may also be the rate at which one can borrow gold over a given time period. Market-based forward curves may also refer to the prices of options, tolling contracts, storage agreements, swing options, inflation protected bonds, etc. In general, market-based forward curves are the prices of any financial contract(s) that can be used as part of a delta hedging (or reverse delta hedging) strategy.

As used herein, the term “risk-free interest/discount rates” refers to the rate of interest paid by a sovereign nation on loans issued in their own currency. These rates are typically different for different start dates and maturities.

As used herein, the term “ghost operating strategy” refers to an operating strategy that management deems optimal given their own views of the future and risk preferences. It is the set of operational choices management would make without the benefit of the embodiments described herein, i.e., the current standard operational practice.

As used herein, the term “ghost hedging strategy” refers to a financial strategy that management deems optimal given their own views of the future and risk preferences. It is the set of financial investment choices management would make without the benefit of the embodiments described herein, i.e., current standard financial investment practice.

### Overview

The invention provides methods and products for improving the profitability of a management strategy for a physical operation that converts a resource into a product or service, whereby a subset of relevant risk factors faced by the physical operation are traded in a financial derivatives market. An example of such a physical operation is (but is not limited to) mining, where a mine's operation includes the determination of what constitutes ore (a resource), and processing of the ore. The goal for management is to design, execute, and/or control its operations in a way they deem best given their views of the future and risk tolerances. Embodiments herein provide a new approaches for designing, executing, and/or controlling such physical operations in a more profitable way. Using tools such as static or dynamic portfolios of financial derivatives, the embodiments can account for management's views of the future and tolerances for risk so that such considerations do not have to impact the physical operation to as great an extent as compared to current practice. Embodiments use variables including a measure of at least one resource to determine different first and second operating models, and include implementing an operating strategy based on the first operating model in the real-world physical operation. The second operating strategy is equivalent to management's current practice. Importantly, the aforementioned first operating model is different from management's current practice and so this new operating model fundamentally alters the design, execution, and/or control of the physical operation. Embodiments provide combined hedging strategies based on the first and second operating models and the measure of the at least one resource that are implemented in a financial market to create a financial strategy that will ensure that when management implements the new operating strategy along with the new financial strategy, that their objectives for the overall operation can be achieved in a more profitable way.

One aspect of the invention provides a framework for implementing optimal operating/hedging strategies, for general operations management problems for which some or all of a firm's major risk factors are traded in financial markets. Previous approaches that have looked into the relationships between operational flexibility and financial hedging have only solved for a single real-world operating strategy for a given operation and have only considered hedging strategies that track the real operation under the real-world operating strategy. A problem with such prior approaches is that they force management into a choice between maximizing market value and expected utility. A feature of the embodiments described herein is an operating/hedging strategy that incorporates multiple operating state models (some real, some imaginary) for the same operation, and in so doing facilitates utility maximizing strategies with the highest possible market value.

In general, embodiments of the invention may be applied to physical operations, i.e., industries, where one or more physical state variable (e.g., resource) can be measured, estimated, and/or modelled and used together with financial variables of price and cost to optimize an operations management strategy. In industries such as shipping and transportation, a physical state variable may be the current geographical location of a vessel (see Example II, below, which describes vessel routing). In commodity extraction industries such as mining, forestry, oil, and gas, a physical state variable may be the amount of the resource that remains to be extracted, as described in detail in Example III, below. In commodity storage industries, inventory level may be a physical state variable. In thermal electrical power industries, physical state variables may include boiler temperature and the time since a unit was activated/de-activated. Such physical state variables play a key role in determining the types of actions that may be taken at a given time, the costs and benefits from each available decision, and they ultimately shape the future evolution of the asset, which in turn will effect long term profits, risks, hedging requirements, and how the physical operation is managed.

Accordingly, embodiments described herein provide an overall operating/trading strategy combination that incorporates at least two separate sets of operating state models for the same operation, along with a trading strategy that is the net result of three sub-strategies. This is shown in the generalized block diagram of FIG. 1. The overall strategy uses as input a measure of one or more physical state variables that affect the market value of the asset, shown at 5. The first operating state model 10 is optimized and a delta hedging strategy 15 is developed under a risk-neutral probability measure (e.g., 7, 9) for the tradeable risk-factors without regard to managerial forecasts or risk preferences towards these factors. Non-tradeable risk factors are valued and optimized under management's subjective probability measure and risk adjustment practice. The actual physical (real-world) operation is managed under the first operating model 10, which is implemented in the physical operation 12. The second operating state model 20 is optimized under management's preferred objective/utility function 4 under a true probability measure that incorporates managerial forecasts 2 for all relevant risk factors. The second operating model 20 includes a ghost operating strategy 22 and a ghost hedging strategy 25. A reverse delta-hedging strategy 30 is derived from the ghost operating strategy 22. Optionally, in some embodiments risk adjustment in the second operating model 20 may require the market value of the first operating model 10 as an input (shown by the dashed line in FIG. 1). The combined hedging strategy 40 therefore consists of the combination of the delta-hedging strategy 15 derived from the first operating state model 10, the ghost hedging strategy 25, and the reverse delta-hedging strategy 30. It will be appreciated that the combined hedging strategy 40 may be implemented in any derivatives market 50. For example, the combined hedging strategy may be implemented with variable notional swaps, commodity leasing agreements, tolling contracts, etc. See, for example, sections 1.6, 3.2.3, 3.2.4, and 3.2.6 of this disclosure.

Thus, referring to FIG. 1 as applied to, for example, a commodity extraction industry such as gold mining, a physical state variable 5 may be the amount of resource, e.g., the size of the total deposit (ore+waste), that remains to be extracted. The output 12 may be the cut-off strategy implemented in the mine that is used to determine which rocks are ore and which are waste, the production schedule, i.e., how much of the gold is extracted, when it is extracted, etc. The output 50 may be used to determine how much gold is sold/bought at spot, versus how much gold is sold/bought forward.

Another aspect of the invention provides a non-transitory computer-readable medium, comprising instructions stored thereon, that when executed on a processor, direct the processor to perform one or more steps of an optimal operating/hedging strategy according to the embodiments described herein, and provide an output. Embodiments may include a user interface (e.g., a graphical user interface (GUI)), and may include functions such as receiving input (e.g., data corresponding to one or more physical state variable, commands from a user, etc.) which may include for example, operations associated with one or more of steps 2, 4, 5, 7 and 9 of FIG. 1, carrying out one or more steps such as, for example, one or more of steps 10, 15, 20, 22, 25, 30, and 40 of FIG. 1, and outputting/displaying results/strategies/images on a display screen, such as, for example, one or both of outputs 12, 50.

Executing instructions may include the processor prompting the user for input at various steps, some of which are shown in FIG. 1. In one embodiment the programmed instructions may be embodied in one or more hardware modules or software modules resident in the memory of a data processing system or elsewhere. In one embodiment the programmed instructions may be embodied on a non-transitory computer readable storage medium or product (e.g., a compact disk (CD), etc.) which may be used for transporting the programmed instructions to the memory of a data processing system and/or for executing the programmed instructions. In one embodiment the programmed instructions may be embedded in a computer-readable medium or product that is uploaded to a network by a vendor or supplier of the programmed instructions, and this medium may be downloaded through an interface to a data processing system from the network by an end user or buyer.

Example I, below, provides detailed description of an implementation of an embodiment where the physical operation is a block model representation of a gold mine. In this example, mathematical details have been omitted for brevity and ease of understanding.

### Example I: Gold Mine Implementation

This section introduces a simplified working example drawn from the gold mining sector.

### Introduction

Each day as a gold mine extracts blocks of rock from a deposit the mining firm must decide what to do with each such block. For example, some blocks that contain a lot of gold will automatically be considered ore and will be sent directly to the mill for processing. Other blocks that contain less gold will be considered waste that will be discarded. Some other blocks with intermediate amounts of gold may be stockpiled for potential later use or will be sent to another type of processing facility such as a leech bed. In this example an operating model or operating strategy for such a gold mine would simply be a way of choosing which blocks fall in which category, and by extension what will be done with each block of rock. By classifying more of the lower gold containing blocks as waste, current production levels can be raised since there will be more gold in each block processed as ore. However, such a course of action will cause there to be less gold produced years in the future when all blocks have been exhausted. Hence the classification of ore is one that must balance the value placed on profits today versus profits that may come far in the future. This decision process is sometimes referred to as cut-off grade optimization or determination.

Cut-off grade determinations depend on a number of physical and financial variables. Important physical variables (e.g., FIG. 1, box 5) may include: the average amount of gold per ton in each block of rock in the deposit, extraction, transportation, processing, and stockpiling constraints, engineering considerations, mine architecture, and other geological/geostatistical information, among other things. Important financial variables may include price and cost forecasts (FIG. 1, box 2), as well as discount rates (FIG. 1, box 4) that relate the firm's value for a dollar received in the future to the value of a dollar received today. Such discount rates typically reflect a firm's cost-of-capital, its appetite for risk, and its assessment of the risk of a project. Note that these are just examples and other factors may also be considered and other ways of dealing with risk may be employed (FIG. 1, box 4). An embodiment as described herein, applied to this gold mining example, determines and changes which blocks of rock are considered ore, which are considered waste, and which fall into some other potential category. In this example, therefore, implementation of an embodiment may fundamentally change the physical movement, extraction, processing, waste, and stockpiling of rock in the mine.

Thus, as applied to a gold mine, the embodiments make gold-containing rock that otherwise may be considered uneconomical due to “opportunity costs” suddenly economical. In essence the embodiments use financial tools to reduce the opportunity costs for mining firms, and in the end result in fundamental changes in the real-world movement of rocks, for example.

### Conventional Practice

In conventional mining practice and mining engineering texts, management will determine some criteria or objective that they wish optimize when classifying blocks of rock (e.g., FIG. 1, box 20). There is then usually some software or model that is used to classify blocks in such a way that will optimize this objective (i.e., the software helps to determine the mine's operating strategy). Most commonly the objective management uses is the maximization of the net present value (NPV) of the future cash flows of the mine. (NPV is the difference between the present value of cash inflows and the present value of cash outflows over a period of time. NPV is used in capital budgeting to analyze the profitability of a projected investment or project.) One of the most commonly used software solutions for maximizing mining NPV applied to a block representation of a mine is MineMax Schedulerm (MineMax, Perth, Australia; www.minemax.com). MineMax Scheduler takes geostatistical and engineering input data along with management's price/cost forecasts and discount rates and determines which blocks of rock are ore, which are waste, and which should be stockpiled and for how long, in order to maximize project NPV. From this operating strategy the software can then output the level of gold production in each future time period as well as a variety of other physical and financial details.

In addition to the production plan produced by software such as MineMax Scheduler, management may also choose to implement a “hedging” strategy. For example, management may choose to sell gold futures or options on a portion of their future production to reduce financial risk. Or they may enter into bilateral contracts with other counterparties to sell some of their future production at a locked-in, pre-specified price in the form of forward or options contracts.

### Implementation Details

In contrast with conventional approaches, the embodiments described herein are completely agnostic to the objective management chooses to optimize, the price, cost, and discount rates management chooses to use, the software model that management chooses to employ, or any other financial agreements they wish to enter into. Management is free to choose these factors in any way they wish and the embodiments will improve upon whatever objective they've chosen. Implementation of an embodiment of the invention not only optimizes the management strategy of the mine, it also fundamentally changes the real-world operation of the mine and the physical movement of rocks.

Consider that a gold mine's management has determined a set of company specific price/cost forecasts (e.g., FIG. 1, box 2), company specific risk adjustment factors or discount rates (e.g., FIG. 1, box 4) and has gathered all relevant physical state variables (e.g., FIG. 1, box 5) including but not limited to: the average amount of gold per ton in each block of rock in the deposit, extraction, transportation, processing, and stockpiling constraints, engineering considerations, mine architecture, and other geological/geostatistical information, among other things. Further, management has inputted this information into their preferred mine optimization software MineMax (for example) and the software recommends the mine plan shown in FIG. 2, that maximizes management's preferred objective (NPV of the mine) subject to their views of the future, appetites for risk, and costs of capital. FIG. 2 shows the optimal amounts of gold production in ounces in each year (right axis) according to management's proprietary inputs and preferred software. FIG. 2 also shows the number of tonnes of ore and waste mined in each year (left axis).

This gold production plan is referred to as the ghost operating strategy in FIG. 1, box 22. This is what management deems to be the best plan given their view of the future and appetite for risk. One of the goals of the embodiments described herein is to find a production plan/financial strategy to exactly match this preferred output in a way that leaves extra gold or extra cash left over.

In addition to this, management may intend to implement some hedging strategy (FIG. 1, box 25) to eliminate some of their risks by selling some of this production forward in the futures market/forward or options markets, for example. For the purpose of this example it is assumed that management is happy with the level of risk that this production plan yields and so doesn't plan on any other hedging activities to alter this gold price exposure profile. FIG. 1, and the subsequent description show how to incorporate any such additional hedging strategy.

Typically the discount rates that mining firms apply to mines that are in operation are around 5% annually based on average cost-of-capital faced by the typical mining firm. Such discount rates are chosen so as to provide shareholders with maximum value, so that to operate using any other discount rate would be to harm the mine's share price. However, gold can be borrowed/leased at much lower rates in the market (on a collateralized basis) using gold lease agreements. FIG. 3 shows historical annual gold lease rates (DLR).

Let's assume that the mining firm negotiated an agreement with a bullion bank that allowed them to borrow gold at a rate of 0.5% annually for each of the next ten years. For simplicity let's also assume that the risk free interest rate for borrowing dollars was 2% and that today's gold price is $1500/ounce. Instead of using management's price forecast, a market based forward curve of prices could be created instead by inflating today's spot price at the risk free rate 2% while deflating it at the agreed upon DLR of 0.5% (this is often referred to as cost-of-carry arbitrage forward pricing in financial literature). In other words, the market based forward curve would have a price forecast in $/ounce for year n given by 1500×(1.02)ⁿ/(1.005)ⁿ. Furthermore it is assumed that the mine is also exposed to future cost inflation risk, and some of this may be related to fuel costs and so the prices of oil futures/forwards may also be used as a form of oil cost forecast. The mine might also be exposed to inflationary risks, so market based inflation factors can be deduced from the difference between inflation protected and non-inflation protected government bonds. If management's original price/cost forecasts are replaced with these forecast (and we created similar market based forecasts for other risk factors that can be hedged), and if management's chosen discount factors are replaced with the risk free rate 2%, and then the MineMax Scheduler is used to create a new production plan based on these new inputs, the results might look like FIG. 4. The production quantities in FIG. 4 correspond to FIG. 1, box 10.

The production plan in FIG. 4 produces less gold initially as compared to management's preferred plan given in FIG. 2, however, it has a longer production over the lifetime of the mine. This is because in the latest plan, prices are inflated at the risk free rate and discounted at the DLR so the net result is as if the NPV of future gold prices only declined at a rate of 0.5% per year; whereas in the original plan, the mine was discounting future prices at a rate of 5% per year. This discrepancy meant that in the original plan it was more important for management to get their money sooner rather than later and so some blocks of rocks containing only small amounts of gold were wasted in order to get at the blocks containing larger amounts of gold sooner. This boosted current production levels at the expense of lower future production that management deemed less valuable (because of the firm's cost-of-capital). This wasting of rock causes the overall mine life to be shorter in the original plan compared to the new plan. However, given management's cost of capital, their appetite for risk and their price/cost forecast, the production plan in FIG. 4 does not maximize management's chosen criteria (NPV) and hence is not the best plan for the mine's management and/or her shareholders. The Minemax software could have selected the production plan in FIG. 4 originally, but chose not to precisely because it didn't maximize management's preferred objectives.

If we were to delta hedge the production plan in FIG. 4, it would mean that we would short gold forward contracts in the amounts given on the right axis for each year from 1-10. Alternatively this could be implemented using a gold leasing strategy as described above.

If we were to implement a reverse delta hedging strategy for the production plan given in FIG. 12, it would mean that we would take a long position in gold forward contracts in the amounts given on the right axis of FIG. 4 for each year from 1-8. Alternatively this could be implemented using a gold leasing strategy as described above.

In this example, the production plan from FIG. 4 is implemented in the real world instead of management's preferred plan shown in FIG. 2. And then the delta hedge for the production plan in FIG. 4 is implemented along with the reverse delta hedge for the production plan in FIG. 2. FIG. 5 shows the output of these two sets of strategies side by side.

FIG. 5 shows management's original (MGMT Optimal) production plan (solid) and a new plan (referred to as ghost path operating (“GPO”) plan) determined according to an embodiment of the invention (hatched). The GPO plan includes the physical output shown in FIG. 4 along with the net of the delta hedging strategy for the production plan from FIG. 4 and the reverse delta hedge for the production plan in FIG. 3.

FIG. 5 shows that net number of ounces of gold produced in both the original plan (i.e., FIG. 1, box 22) that is currently used in practice, and the GPO plan which is a combination of a physical strategy (FIG. 1, box 10) and the combined hedging strategies of FIG. 1, boxes 15 and 30. It is noted that the GPO plan exactly matches the output of the original plan from years 1-8. Then the original plan has no gold left due to the higher rate of wasting rock, whereas the new GPO plan still shows production in years 9 and 10.

FIG. 6 shows how the GPO strategy works. In the real physical world management produces according to the levels shown as GPO Physical (black). When this level is lower than management's original plan (i.e., MGMT Optimal in FIG. 5), which management prefers to the GPO Physical plan, the difference is made up for by borrowing gold from the market at the DLR of 0.5%. Eventually, due to the fact that the GPO plan has less waste, the production quantities of the GPO physical plan will be higher than management's preferred plan and this over production can be used to pay back the previous gold loans with interest. The financial borrowing/repayment plans are shown striped. These are the net result of implementing the delta hedge for the production plan of FIG. 4 and the reverse delta hedge for the production plan of FIG. 2. The amounts that are left over are free gold for the mine and extra profit over what would have been achieved had management not used the GPO plan combination.

Referring to FIG. 6, it is noted that management could, if they wished, lock in the value of the excess gold produced in years nine and ten of the GPO plan by borrowing gold equal to these amounts discounted at the DLR today and sell this gold to the market at the current spot. To ensure that the production costs of processing and extracting the gold required to repay these loans were locked in, management could use some of the proceeds from the sale of the borrowed gold to purchase inflation protected bonds with a face value equal to the future production cost (they could do similar things for other hedgeable risk factors as well). From this point on whenever the physical production costs of the GPO plan are lower than those of management's original plan the savings can be invested the same as above, and whenever the physical costs of the GPO plan are higher than those of management's original plan these savings can be withdrawn to pay for these increased costs. This process thereby ensures that the cost profiles between the GPO and original mine plans match exactly through the first 8 year time horizon. And after year eight the costs for years nine and ten are paid for from the original amounts saved in year zero. In fact this last financial component is the sum of the delta and reverse delta hedges as applied to the cost components.

As demonstrated in this example, the revenues and costs of the GPO plan exactly match those of management's original plan, except that there are two extra years of production in the GPO plan, the profits from which have been lock-in. The two extra years of production result from implementation of the physical strategy in the mine, which avoids the extra wasting of rock as determined according to the GPO plan. The net result is a net gold price, and production cost exposure profile that is exactly the same as that of management's original plan, except the new plan also provides two years of extra, locked in profits that in this example are monetized upfront in year zero.

This example provides a simplified overview of how an embodiment may be implemented in a gold mine. It is important to note that embodiments may be implemented in any physical operation for which management has production flexibility that they can optimize and a financial market through which they can implement hedges. The details of what the underlying risk factors are, whether resource is gold, oil, gas, electricity, shipping, counter-party credit, interest rate, inflation, etc., are immaterial to the embodiments. Management's choices of objectives they wish to achieve with their production flexibility are immaterial to the embodiments. The black-box model and/or software management chooses to use to determine their optimal course of action based on their objectives is also immaterial to the embodiments. That is, any of these components may be replaced with any other choice and the GPO physical strategy determination coupled with the GPO mixture of financial hedges will produce an enhanced profit outcome such as that demonstrated in the above example. This is because none of those arbitrary choices is actually used; only the outputs of those choices are needed to implement the GPO strategy.

Further description is provided below:

Section 1 provides detailed description of embodiments.

Section 2, Example II provides detailed description of the implementation of an embodiment where the physical operation is shipping.

Section 3, Example III provides detailed description of the implementation of an embodiment where the physical operation is drawn from mining.

### 1. Detailed Description of Embodiments

In the this section we will consider the problem in which management is presented with an operation that converts resources into goods and services, whereby some subset of the relevant risk factors faced by the operation are traded in a financial derivatives market. The goal for management is to design, execute and/or control these operations in a way management deems optimal.

### 1.1. Definitions and Preliminary Theoretical Results.

We will assume that planning is done over a finite time horizon and we will assume that operational decisions are made at a discrete set of times Tₖ for k=1, . . . , N_{T}. Since it will often be necessary to simultaneously take both long and short positions in the same risk factor corresponding to different forward time periods, the entire forward curve will be modeled. The set of forward curves for the inputs/outputs will be denoted by: fᵢ(t,Tₖ) for i=1, . . . , N_{f}, where N_{f} is the number of different forward curves (commodities), t is the time of observation and Tₖ denotes the delivery time. The spot price of the i^{th} commodity at time Tₖ is therefore fᵢ(Tₖ,Tₖ). Let F(t) be a vector of length N_{T}×N_{f} such that

F(t)=[f₁(t,T₁),f₁,(t,T₂), . . . ,f₁(t,T_{N}_{_{T}}),f₂(t,T₁), . . . ,f₂(t,T_{N}_{_{T}}), . . . ,f_{N}_{_{f}}(t,T₁), . . . ,f_{N}_{_{f}}(t,T_{N}_{_{T}})]. (1)

Note that the j^{th} element of F corresponds to curve number

$$k = j - {N}_{T} floor ( \frac{j - 1}{{N}_{T}} ) .$$

and to delivery time number

$$i = floor ( \frac{j - 1}{{N}_{T}} ) + 1$$

Alternatively, the value of fᵢ(t,Tₖ) can be found in the j=N_{T}(i−1)+k entry of vector F(t). The spot price at time Tₖ for commodity i is given by

Sᵢ(Tₖ)=F_{N}_{_{T}}₍ᵢ₋₁₎₊ₖ(Tₖ). (2)

We shall denote the vector of spot price values for all commodities 1, . . . , N_{f} at time Tₖ as S(Tₖ).

We will employ a generalization of the discrete string model of the forward curve commonly used in industry (see Eydeland and Wolyniec (2003)) and that traces its origin to Kennedy (1997). To that end we will assume that each observable contract Fⱼ(t)∈F(t) satisfies a general SDE of the form

$$d {F}_{j} ( t ) = \{ \begin{matrix}{μ}_{j} ( F ( t ) , t ) d t + {σ}_{j} ( F ( t ) , t ) d {Z}_{j} ( t ) & for t \leq {T}_{k = j - {N}_{T} floor ( \frac{j - 1}{{N}_{T}} )} \\ 0 & for t > {T}_{k = j - {N}_{T} floor ( \frac{j - 1}{{N}_{T}} )}\end{matrix} for j = 1 , … , {N}_{f} \times {N}_{T} \qquad ( 3 )$$

where each dZⱼ(t) is a standard increment of Brownian motion drawn from N(0, \sqrt{dt}) and where E[dZᵢ(t)dZⱼ(t)]=ρᵢⱼ(F(t), t)dt i.e. the correlation between increments are given by the functions ρⱼₘ. For ease of exposition we will suppress the functional dependence notation and use μⱼ=μⱼ(F(t),t), σⱼ=σⱼ(F(t),t) and ρᵢⱼ=ρᵢⱼ(F(t),t) as short hand notation.

Equation (3) describes the actual evolution of the financial variables in the real-world as perceived by management, given the information available at time t. There is another imaginary world called the “risk-neutral” world in which it is assumed that:

$$d {F}_{j} ( t ) = \{ \begin{matrix}{σ}_{j} ( F ( t ) , t ) d {Z}_{j} ( t ) & for t \leq {T}_{k = j - {N}_{T} floor ( \frac{j - 1}{{N}_{T}} )} \\ 0 & for t > {T}_{k = j - {N}_{T} floor ( \frac{j - 1}{{N}_{T}} )}\end{matrix} for j = 1 , … , {N}_{f} \times {N}_{T} \qquad ( 4 )$$

The dynamics in this imaginary world will be used to facilitate certain financial calculations. We will refer to a world in which the dynamics of F(t) are given by (3) as the true-measure world P and the imaginary risk-neutral world in which the dynamics of F(t) are given by (4) as the risk-neutral-measure world Q.

In order to facilitate the use of stochastic volatility models for which hedging requires the addition of other volatility sensitive hedging products such as options, some of the “forward-curves” fᵢ could be viewed as being options on commodity forward contracts with a range of expiry dates. Note that for consistency of notation, the independent variables used in any such stochastic volatility representation should be implemented using either the options prices as the risk-factors or using the forward volatilities as the risk factors, otherwise a different notational system would be needed to represent the risk-neutral measure for those risk factors. By incorporating stochastic volatility and options into the description, a more general class of financial models and hedging strategies can be considered within the same framework.

In addition to the financial variables we will assume that the operation can be discretized into a finite number of operating states, which determine the level of output, the costs and benefits, and the set of possible decisions available to management. While extension to a continuous operating state framework is equally possible, for simplicity we will focus on discrete operating state representations or approximations. The operating states will be numbered from 1 to L. Let Lₖ represent the state before making a decision at time Tₖ. At each time Tₖ an action αₖ can taken from a set of feasible actions [symbol] ₖ(Lₖ) after which the operating state advances to Lₖ+αₖ i.e.

Lₖ₊₁=Lₖ+αₖ (5)

and a reward πₖ(αₖ, Lₖ, S(Tₖ)) is received. The set of feasible actions will often include restrictions designed to take operational constraints into account.

### Definition 1. (Operating Strategy)

An operating strategy α(F(Tₖ), Lₖ,Tₖ)∈ [symbol] is any feasible ride for determining the action, given the current values of all financial variables F(Tₖ), the current operating state Lₖ and the decision time Tₖ.

To ease the notational requirements we will denote αₖ=α(F(T),Lₖ,Tₖ) to be the operating strategy function at time Tₖ given all all the relevant information at time Tₖ and we will denote \vec{α} to be the vector of all functions αₖ for k=1, . . . N_{T}. We will also denote the operating state at Tₖ under the operating strategy \vec{α} as Lₖ^{\vec{α}}.

Given the filtration of F at t (the path of F from t=0 to t=t), given the initial state L₁, and given any operating strategy \vec{α}, the value of the operating state under this strategy at time t, denoted as L^{\vec{α}}(t) is given by:

$${L}^{\vec{α}} ( t ) = {L}_{1} + {\sum }_{j = 1}^{k} α ( F ( {T}_{j} ) , {L}_{j} , {T}_{j} ) where k is such that {T}_{k} \leq t < {T}_{k + 1} . \qquad ( 6 )$$

Note L^{\vec{α}}(t) is constant between decision dates. We will also denote πₖ^{\vec{α}}=πₖ(αₖ, Lₖ^{\vec{α}}, S(Tₖ)) to be the payoff at time Tₖ that results from the operating strategy \vec{α} at time Tₖ given the relevant information at time Tₖ.

In addition to an operating strategy, management is assumed to have access to a liquid financial market through which they may execute a financial trading strategy in order to improve, enhance or modify future, risk/reward outcomes. The following defines a trading 2s strategy along with the total outcome of implementing such a strategy over a prescribed time horizon.

### Definition 2. (Trading Strategy)

Let [symbol] be the path of all financial variables F(t) from time t=0 to time t=t. A [symbol] -trading strategy is a vector of functions Δ( [symbol] ,L^{\vec{α}}(t),t) of length N_{T}×N^{T} whose j^{th} element represents a function that determines the quantity of forward contract j to be held at time t given the values of the relevant market and operating state information of the operation to be hedged. We will assume that each payoff period k has its own associated trading strategy from time t=0 to t=Tₖ and to ease the notational burden we will denote: Δₖ(t)=Δₖ( [symbol] , L^{\vec{α}}(t),t). We will denote the collection of all of these N_{T} trading strategies as \vec{Δ}. If all proceeds of a trading strategy are reinvested at the risk free rate rₖ until the end of the corresponding period Tₖ, then the total cumulative profit/loss from a trading strategy Δₖ over the time period 0≤t≤Tₖ is given by

∫₀^{T}^{ₖ}e^{r}^{ₖ}^{(T}^{ₖ}^{-τ)}Δₖ(τ)·dF(τ)′. (7)

The intuition behind equation (7) is that if at each time r management holds Δₖ(τ) amounts of the various forward contracts, and if over a small time interval from τ to τ+dτ the forward contracts change from F(τ) to F(τ+dτ), then the total profit of the trading strategy over this time interval would be Δₖ(τ)·(F(τ+dτ)′−F(τ)′)=Δₖ(τ)·dF(τ)′. At time τ+dτ the hedge is re-balanced to be Δₖ(τ+dτ) and the same profit process is repeated. If all of these profits are invested at the risk free rate rₖ until time Tₖ then as the length of each time interval goes to zero (dτ→0), the total cumulative size of these profits at time Tₖ would be given by equation (7).

This simple definition of a trading strategy is remarkably powerful. The lemma that follows will show that, when such strategies are chosen correctly, it is possible to synthetically replicate the change in market value of any operation, or any derivative, or portfolio of derivatives, with any payoffs one can imagine. Thus an infinite range of financial payoff structures can be replicated with such trading strategies.

### Lemma 1. (Synthetic Financial Replication)

Let \vec{α} be any feasible operating strategy and let Vₖ^{\vec{α}}(F,L^{\vec{α}},t)=E_{Q}[πₕ^{\vec{α}}(t)=F, L^{\vec{α}}(t)=L^{\vec{α}}] be the expected value under the risk neutral measure Q of the payoff at time Tₖ from following operating strategy \vec{α} given the information about the financial market and the operating state at time t=t. Let

$${Δ}_{k}^{\vec{α}} ( t ) = {e}^{- {r}_{k} ( {T}_{k} - t )} ∇ {V}_{k}^{\vec{α}} = {e}^{- {r}_{k} ( {T}_{k} - t )} [ \frac{\partial {V}_{k}^{\vec{α}}}{\partial {F}_{1}} , \frac{\partial {V}_{k}^{\vec{α}}}{\partial {F}_{2}} , … , \frac{\partial {V}_{k}^{\vec{α}}}{\partial {F}_{{N}_{T} \times {N}_{f}}} ] \qquad ( 8 )$$

be a financial strategy. Then under every realization of the future and all probability measures:

∫₀^{r}^{ₖ}^{(T}^{ₖ}^{-τ)}Δₖ^{\vec{α}}(τ)·dF′(τ)=πₖ^{\vec{α}}−E_{Q}[πₖ^{\vec{α}}|F(0),L₁] (9)

For a proof see Thompson et al. (2017).

To see the significance of the Synthetic Replication Lemma, assume that we implemented operating strategy \vec{α} in the physical operation and at the same time we implemented the trading strategy −Δₖ^{\vec{α}}(t). Then the payoff at time T of the physical operation would be πₖ^{\vec{α}} and according to the Synthetic Replication Lemma the payoff from the trading strategy would be: −πₖ^{\vec{α}}+E_{Q}[πₖ^{\vec{α}}|F(0),L₁]. Combining these two payoffs together gives E_{Q}[πₖ^{\vec{α}}|F(0),L₁]. This means that under all possible price paths (and hence under all probability measures), the combination of operating/trading strategy will always result in whatever E_{Q}[πₖ^{\vec{α}}|F( ),L₁] was at time t=0, no matter what happens after this time. Thus, this operating/trading strategy combination results in a stream of risk free payoffs for each k. In order for there not to be an arbitrage, all risk-free payoffs must return the risk-free rate, since it costs nothing initially to enter into the trading strategy, if the risk-free rate in each period is rₖ then the market value of the operating strategy must be equal to the sum of these risk-free payoffs each discounted at the corresponding risk-free rate. We will therefore refer to the value found in this way as the market value of the operating strategy.

### Definition 3. (Market Value of an Operating Strategy)

The fair arbitrage-free market value of the operation, under operating strategy \vec{α} is given by:

$${\sum }_{k = 1}^{{N}_{t}} {e}^{- {r}_{k} {T}_{k}} {E}_{Q} [ {π}_{k}^{\vec{α}} \vert F ( 0 ) , {L}_{1} ] . \qquad ( 10 )$$

Since for any given operating strategy, we can find an associated market value, a natural choice would be to find the strategy with the highest market value. This brings us to the following definition.

### Definition 4. (Market Value Maximizing Operating Strategy)

The market value maximizing operating strategy n is a feasible strategy that maximizes:

$${max}_{\vec{Ω} ∈ 𝒜} {\sum }_{k = 1}^{{N}_{t}} {e}^{- {r}_{k} {T}_{k}} {E}_{Q} [ {π}_{k}^{\vec{Ω}} \vert F ( 0 ) , {L}_{1} ] . \qquad ( 11 )$$

Now that we have defined the operating and trading strategies we will discuss the objective function management wishes to maximize to determine these strategies. For maximum generality, assume that management has determined an objective function that they want their operating/trading strategy to maximize. For simplicity we will refer to this objective as the utility function U. If there are N_{T} time periods then U is a function that maps from [symbol] ^{N}^{_{T+1}}→ [symbol] . So that if there are a series of cash-flows: C₀, C₁, C₂, . . . , C_{N}_{_{T}} that arrive at times 0, T₁, T₂, . . . , T_{N}_{_{T}} then U(C₀, C₁, C₂, . . . , C_{N}_{_{T}}) would provide a single numerical “value” and it is this value that management wishes to be maximized.

We will make two assumptions about this function U. The first is that it prefers more wealth to less i.e. if ϵ>0 then

U(C₀+ϵ,C₁,C₂, . . . ,C_{N}_{_{T}})>U(C₀,C₁,C₂, . . . ,C_{N}_{_{T}}). (12)

The second assumption is that it will never prefer for management to lose money to an arbitrage opportunity. In particular, if a set of cash-flows C₀, C₁, C₂, . . . , C_{N}, are all completely risk-free and known with absolute certainty, and if the risk-free discount rate corresponding to each future time Tₖ is rₖ then:

$$U ( {C}_{0} + {\sum }_{k = 1}^{{N}_{T}} {e}^{- {r}_{k} {T}_{k}} {C}_{k} , 0 , 0 , … , 0 ) = U ( {C}_{0} , {C}_{1} , {C}_{2} , … , {C}_{{N}_{T}} ) . \qquad ( 13 )$$

This assumption basically states that if we have a stream of risk-free cash-flows we should never value them more/less than a risk-free bond with the same payoffs, since we could always buy/sell the corresponding bonds in order to move risk-free cash-flows forward or backward in time. For example assume that management knew they had a risk free cash-flow Cₖ that was due to arrive at some future time Tₖ, but for whatever reason, they really needed cash sooner at t=0. In that case, no matter how much they needed the money today, they would never accept any less than e^{-r}^{ₖ}^{T}^{ₖ}Cₖ in exchange for said future cash-flow. This is because they always could simply go to the market and borrow a risk-free zero-coupon bond with a face value of Cₖ, use the risk-free future cash-flow Cₖ as collateral on the bond loan to eliminate the credit risk cost of said loan, and then sell said bond to the market for an amount e^{-r}^{ₖ}^{T}^{ₖ}Cₖ.

In theory management's ultimate objective can be stated as finding a feasible operating strategy \vec{α} and a set of trading strategies \vec{Δ} to maximize the expected value of U under the true probability measure P, given the filtration at time t=0. Given the definitions in this paper, this goal is equivalent to:

$${max}_{\vec{α} ∈ 𝒜 , \vec{Δ} } {E}_{P} [ U ( 0 , {π}_{1}^{\vec{α}} + {\int }_{0}^{{T}_{1}} {e}^{{r}_{1} ( {T}_{1} - t )} {Δ}_{1} ( t ) d {F}^{′} ( t ) , … , {{π}_{{N}_{T}}^{\vec{α}} + {\int }_{0}^{{T}_{{N}_{T}}} {e}^{{r}_{{N}_{T}} ( {T}_{{N}_{T}} - t )} {Δ}_{{N}_{T}} ( t ) d {F}^{′} ( t ) ) ]}_{t = 0} . \qquad ( 14 )$$

In the above we have assumed that T₁ is the first date at which there is a potential payoff.

The difficulty with the above optimization problem is that it is utterly intractable due to its infinite dimensionality. It is possible to have a different value for \vec{Δ} for each path of the financial variables [symbol] . Since there is an infinite number of possible paths for the financial market to traverse, there are an infinite number of optimizable parameters in \vec{Δ}. So that while equation (14) theoretically covers all possible operating/trading strategy combinations, in practice solving this equation is an intractable problem.

In practice therefore management is forced to limit the number of possible path-dependent trading strategy variables to some finite value, and then find an operating/trading strategy solution to equation (14) based on this finite state space restriction. If management were to do this and solve for an operating/trading strategy combination \vec{α} and \vec{Δ} based on such a restricted state space then it is likely that the value of a may not be the same as the market value maximizing operating strategy \vec{Ω} defined in problem (11). In such cases the following theorem shows how to create a new operating/trading strategy with an even larger value for equation (14).

### Theorem 1.

Let \vec{α} and \vec{Δ} be any operating/trading strategy combination. Let \vec{Ω} be the market value maximizing strategy defined m problem (11). And assume that \vec{Ω}≠\vec{α} so that:

$${\sum }_{k = 1}^{{N}_{t}} {e}^{- {r}_{k} {T}_{k}} {E}_{Q} [ {π}_{k}^{\vec{Ω}} \vert F ( 0 ) , {L}_{1} ] > {\sum }_{k = 1}^{{N}_{t}} {e}^{- {r}_{k} {T}_{k}} {E}_{Q} [ {π}_{k}^{\vec{α}} \vert F ( 0 ) , {L}_{1} ] . \qquad ( 15 )$$

Let Δₖ^{\vec{α}}(t)=e^{-r}^{ₖ}^{(T}^{ₖ}^{-t)}∇ₖ^{\vec{α}} and Δₖ^{\vec{Ω}}(t)=e^{-r}^{ₖ}^{(T}^{ₖ}^{-t)}∇ₖ^{\vec{Ω}}. Then under all possible future price paths (and therefore all probability measures) the difference in profit between implementing the operating strategy N coupled with the trading strategies: [Δₖ+Δₖ^{\vec{α}}−Δₖ^{\vec{Ω}}] for all k=1, . . . , N_{T} versus implementing operating strategy \vec{α} coupled with trading strategy \vec{Δ} will be a known risk-free amount given by:

$${\sum }_{k = 1}^{{N}_{t}} {e}^{- {r}_{k} {T}_{k}} {E}_{Q} [ {π}_{k}^{\vec{Ω}} \vert F ( 0 ) , {L}_{1} ] - {\sum }_{k = 1}^{{N}_{t}} {e}^{- {r}_{k} {T}_{k}} {E}_{Q} [ {π}_{k}^{\vec{α}} \vert F ( 0 ) , {L}_{1} ] > 0. \qquad ( 16 )$$

Therefore by assumptions (12) and (13) the former (Ghost-Path enhanced) strategy must always be superior to the latter (traditional approach).

For a proof see Thompson et al. (2017).

An important implication of Theorem 1 is that the optimal physical operating strategy \vec{Ω} is the market value optimizing strategy that is shared with CC theory. This means that in the complete market case, the optimal physical operating strategy is independent of management's view of future prices, their appetites for risk, their definition of risk or their preferred objectives. Theorem 1 states that these factors should only enter into the financial trading strategy component and never the operating strategy component.

A natural question one might ask is: since we know that the optimal operating strategy is going to be \vec{Ω} anyway, then why not constrain the optimization problem (14) to have \vec{α}=\vec{Ω}? If problem (14) were tractable then that would be a fine strategy. But since such a problem is not tractable we are forced to limit the number of possible path dependencies in the trading strategy to a finite number. If that is the case then also restricting \vec{α}=\vec{Ω} would reduce the degrees of freedom even further. A better approach is to identify optimal values for \vec{α} and \vec{Δ} from some tractable, restricted form of the objective function (14), and then use Theorem 1 to improve upon these results. This would then result in two path dependent operating strategies \vec{α} and \vec{Ω}. \vec{Ω} would be implemented physically in the real-world and a ghost operating strategy \vec{α} would be implemented synthetically in the financial market.

### 1.2. Algorithmic Implementation Complete Market Case.

Theorem 1 showed that the Bhost-Path enhanced technique always gives rise to an improved set of outcomes whenever the market value maximizing strategy (i.e. strategy found by assuming a risk neutral utility with expectations maximized under probability measure Q) does not also happen to maximize the expected value of management's preferred utility function under the true probability measure P. However, just being superior to something that is sub-optimal, is not the same as being optimal. It is possible that by using the Ghost-Path approach (which increases the expected value of the operation without changing any other moment of the profit distribution), management's attitude towards risk may in fact change, which may in turn lead to a change in the optimal values of \vec{α} and \vec{Δ}. To avoid this recursion the utility maximizing strategies \vec{α} and \vec{Δ} should be found after the market value maximizing strategy f has been identified. Hence the following three step procedure is what should be implemented in practice.
Determine \vec{Ω} by solving the maximization problem (11).
Find \vec{α} and \vec{Δ} by solving a tractable version of:

$${max}_{\vec{α} ∈ 𝒜 , \vec{Δ}} {E}_{P} [ U ( χ , {π}_{1}^{\vec{α}} + {\int }_{0}^{{T}_{1}} {e}^{{r}_{1} ( {T}_{1} - t )} {Δ}_{1} ( t ) d {F}^{′} ( t ) , … , {{π}_{{N}_{T}}^{\vec{α}} + {\int }_{0}^{{T}_{{N}_{T}}} {e}^{{r}_{{N}_{T}} ( {T}_{{N}_{T}} - t )} {Δ}_{{N}_{T}} ( t ) d {F}^{′} ( t ) ) ]}_{t = 0} . \\ where \\ χ = {\sum }_{k = 1}^{{N}_{t}} {e}^{- {r}_{k} {T}_{k}} {E}_{Q} [ {π}_{k}^{\vec{Ω}} \vert F ( 0 ) , {L}_{1} ] - {\sum }_{k = 1}^{{N}_{t}} {e}^{- {r}_{k} {T}_{k}} {E}_{Q} [ {π}_{k}^{\vec{α}} \vert F ( 0 ) , {L}_{1} ]$$

Implement operating strategy \vec{Ω} in the real-world operations and the trading strategies: [Δₖ+Δₖ^{\vec{α}}−Δₖ^{\vec{Ω}}] for all k=1, . . . , N_{T} in the financial markets.

### 1.3. Ghost-Path Hedging Approach in Partially Complete Markets.

In the this section we will consider the case in which management is presented with an operation that converts resources into goods and services, whereby only some of the relevant risk factors are traded in a complete financial market. For example, in some cases it maybe that the prices that trade in the financial markets are only proxies for the actual prices received/paid by the firm, and the true price is some random spread on the financial market value which is not revealed until final delivery is negotiated. Uncertainty in the production amounts is another possibility. For example, a gold mine processing ore at a certain rate may find that the actual amount of gold produced at a given time may be greater/lesser than expected due to geological uncertainties in the amount of gold contained in a given sample of ore. Other examples may include mechanical failures in a power plant that may cause the actual amount of power to be less than originally planned. These types of risks generally have components that are uncorrelated with the financial markets and therefore cannot be hedged.

In this section we will discuss how to modify the previous results to the partially complete market case in which only some risk factors are traded in a complete market. Once again the goal is to design, execute and control these operations in a way management deems optimal.

Assume that at any given time Tₖ the actual payoff is of the form:

πₖ(αₖ,Lₖ^{\vec{α}},S(Tₖ))+ϵₖ^{\vec{α}} (17)

where ϵₖ^{\vec{α}} is a random variable drawn from some arbitrary probability distribution Dₖ(ϵ;αₖ,Lₖ^{\vec{α}},S(Tₖ)), the parameters of which may depend on the time Tₖ the operating state Lₖ^{\vec{α}} and the spot prices S(Tₖ) at the time of payoff Tₖ.

For the purpose of obtaining analytical results similar to those of Theorem 1 in the partially complete market case we will also make two additional assumptions (in agreement with Smith and Nau (1995)) regarding the utility function U. In particular we will assume that the firm's preferences for risky cash-flows through time, depend only on the marginal distributions at each time period k and not on the joint distribution. This means that management's objective can be written as:

$$max {\sum }_{k = 1}^{{N}_{T}} {E}_{P} [ {c}_{k} {u}_{k} ( \cdot ) ] \qquad ( 18 )$$

for some marginal utility functions uₖ and constants cₖ. We will also assume that each utility function uₖ exhibits constant absolute risk aversion. We stress that the last of the above assumptions is only for the purpose of generating an analytical proof as opposed to individual numerical studies. We will subsequently describe the ghost-path hedging algorithm in cases where uₖ(⋅) are general utility functions.

This framework means that we can compare any two sets of uncertain cash-flows resulting from different operating/trading strategies in the following way. First, since the overall utility function depends only on the marginal utility functions at each time-period, so must the expected utility. And since the expected value of a sum is the sum of the expected values, the overall expected utility can be calculated by summing the individual expected utilities. Thus for any operating/trading strategy combination we can compute the certainty equivalents of a each utility function u separately to determine a stream of certain cash-flows that management values equally as much as the original uncertain cash-flow stream. By the no-arbitrage condition given in equation (13) we know that any certain cash-flow stream must be equivalent to an upfront lump sum payment equal to the NPV of the stream discounted at the risk free rate that applies over each time-period. By the transitivity property of utility functions, management must also be indifferent between such a lump sum value and the original uncertain cash-flow stream.

Each function uₖ will depend on the payoff at time period T which in turn will depend on the operating strategy, operating state, as well as both the spot prices of the financial variables and on the non-financial risk factor et. Once more we will denote αₖ=αₖ(F(Tₖ), Lₖ^{\vec{α}},Tₖ) to be the operating strategy and πₖ^{\vec{α}}+ϵₖ^{\vec{α}}=rₖ(αₖ, Lₖ^{\vec{α}}, S(Tₖ))+ϵₖ^{\vec{α}} to be the payoff at time Tₖ that results from using the operating strategy d given all of the relevant information at time Tₖ.

The theoretical objective therefore can be stated as finding a feasible operating strategy \vec{α} and a set of trading strategies, \vec{Δ} to maximize the expected utility under the true probability measure P given the filtration at time t, i.e. such a goal can be stated as:

$${max}_{\vec{α} ∈ 𝒜 , \vec{Δ}} {\sum }_{k = 1}^{{N}_{T}} {e}^{- {r}_{k} {T}_{k}} {E}_{P} [ {c}_{k} {u}_{k} ( {π}_{k}^{\vec{α}} + {ϵ}_{k}^{\vec{α}} + {\int }_{0}^{{T}_{k}} {e}^{{r}_{k} ( {T}_{k} - t )} {Δ}_{k} ( t ) d {F}^{′} ( t ) ) \vert F ( 0 ) , {L}_{1} ] . \qquad ( 19 )$$

### 1.4. Main Theoretical Results.

The first important theoretical result, is the partially complete market analogue of the Synthetic Replication Lemma.

### Lemma 2. (Synthetic Certainty Equivalent Replication)

Let \vec{α} be any feasible operating strategy and let Vₖ^{\vec{α}}(F, L^{\vec{α}},t) E_{Q}[uₖ⁻¹(E_{P}[uₖ (πₖ^{\vec{α}}+ϵₖ^{\vec{α}}])|F(Tₖ),Lₖ^{\vec{α}})|F(t)=F, L^{\vec{α}}(t)=L^{\vec{α}}] be the expected certainty equivalent value of the payoff at time Tₖ, under the risk-neutral measure Q, obtained by following operating strategy \vec{α}, given the information about the financial market and the operating state at time t=t. (Note: the inner expectation in the definition of Vₖ^{\vec{α}} is taken over the uncertain value of ϵₖ^{\vec{α}} under management's true probability distribution, conditioned on the time Tₖ values of F and L^{\vec{α}} which are themselves unknown random quantities at t=t). Let

$${Δ}_{k}^{\vec{α}} ( t ) = {e}^{- {r}_{k} ( {T}_{k} - t )} ∇ {V}_{k}^{\vec{α}} = [ \frac{\partial {V}_{k}^{\vec{α}}}{\partial {F}_{1}} , \frac{\partial {V}_{k}^{\vec{α}}}{\partial {F}_{2}} , … , \frac{\partial {V}_{k}^{\vec{α}}}{\partial {F}_{{N}_{T} \times {N}_{f}}} ] \qquad ( 20 )$$

be a financial strategy. Then under every realization of the future and all probability measures:

∫₀^{T}^{ₖ}e^{r}^{ₖ}^{(T}^{ₖ}^{-τ)}Δₖ^{\vec{α}}(τ)·dF′(τ)=uₖ⁻¹(E_{P}[uₖ(πₖ^{\vec{α}}+ϵₖ^{\vec{α}})|F(Tₖ),Lₖ^{\vec{α}}])−E_{Q}[uₖ⁻¹(E_{P}[uₖ(πₖ^{\vec{α}}+ϵₖ^{\vec{α}}])|F(Tₖ),Lₖ^{\vec{α}})|F(0),L₁]. (21)

For a proof see Thompson et al. (2017).

The Synthetic Certainty Equivalent Replication Lemma facilitates the main result analogous to Theorem 1 in partially complete markets. The following definition analogous to the Market Value Maximizing Operating Strategy definition from the previous section.

### Definition 5. (Certainty Equivalent Market Value Maximizing Operating Strategy)

The certainty equivalent market value maximizing operating strategy \vec{Ω} is the feasible strategy that maximizes the sum of the expected values under the risk neutral probability measure Q, over the variables F and L^{Ω}, of the certainty equivalent of the value of the payoffs at each time Tₖ, over the random variables ϵₖ under management's true probability measure, discounted at the risk-free rate. i.e:

$${max}_{\vec{Ω} ∈ 𝒜} ( {\sum }_{k = 1}^{{N}_{t}} {e}^{- {r}_{k} {T}_{k}} {E}_{Q} [ {u}_{k}^{- 1} ( {E}_{P} [ {u}_{k} ( {π}_{k}^{\vec{Ω}} + {ϵ}_{k}^{\vec{Ω}} ) \vert F ( {T}_{k} ) , {L}_{k}^{\vec{Ω}} ] ) \vert F ( 0 ) , {L}_{1} ] ) . \qquad ( 22 )$$

### Theorem 2.

Let \vec{α} and \vec{Δ} be any feasible operating/trading strategy combination. Let \vec{Ω} be the maximizing strategy defined in equation (22) and assume that \vec{Ω}≠\vec{α} so that:

$${\sum }_{k = 1}^{{N}_{t}} {e}^{- {r}_{k} {T}_{k}} {E}_{Q} [ {u}_{k}^{- 1} ( {E}_{P} [ {u}_{k} ( {π}_{k}^{\vec{Ω}} + {ϵ}_{k}^{{Ω}^{\to }} ) \vert F ( {T}_{k} ) , {L}_{k}^{\vec{Ω}} ] ) \vert F ( 0 ) , {L}_{1} ] > {\sum }_{k = 1}^{{N}_{t}} {e}^{- {r}_{k} {T}_{k}} {E}_{Q} [ {u}_{k}^{- 1} ( {E}_{P} [ {u}_{k} ( {π}_{k}^{\vec{α}} + {ϵ}_{k}^{\vec{α}} ) \vert F ( {T}_{k} ) , {L}_{k}^{\vec{Ω}} ] ) \vert F ( 0 ) , {L}_{1} ] . \qquad ( 23 )$$

Let Δₖ^{\vec{α}}(t)=e^{-r}^{ₖ}^{(T}^{ₖ}^{-t)}∇Vₖ^{\vec{α}} and Δₖ^{\vec{Ω}}(t)=e^{-r}^{ₖ}^{(T}^{ₖ}^{-t)}∇Vₖ^{\vec{Ω}}. Then under the true, real-world probability measure P the difference in expected utility between implementing the operating strategy Q coupled with the trading strategies: Δₖ+Δₖ^{\vec{α}}−Δₖ^{\vec{Ω}} for all k=1, . . . , N_{T} versus implementing the operating strategy \vec{α} coupled with trading strategy \vec{Δ} will always be positive i.e.:

$${\sum }_{k = 1}^{{N}_{T}} {E}_{P} [ {c}_{k} {u}_{k} ( {π}_{k}^{\vec{Ω}} + {ϵ}_{k}^{\vec{Ω}} + {\int }_{0}^{{T}_{k}} {e}^{{r}_{k} ( {T}_{k} - τ )} [ {Δ}_{k} ( τ ) + {Δ}_{k}^{\vec{Ω}} ( τ ) - {Δ}_{k}^{\vec{Ω}} ( τ ) ] {dF}^{′} ( τ ) ) \vert F ( 0 ) , {L}_{1} ] > {\sum }_{k = 1}^{{N}_{T}} {E}_{P} [ {c}_{k} {u}_{k} ( {π}_{k}^{\vec{α}} + {ϵ}_{k}^{\vec{α}} + {\int }_{0}^{{T}_{k}} {e}^{{r}_{k} ( {T}_{k} - τ )} {Δ}_{k} ( τ ) {dF}^{′} ( τ ) ) \vert F ( 0 ) , {L}_{1} ] . \qquad ( 24 )$$

For a proof see Thompson et al. (2017).

### 1.5. Algorithmic Implementation Partially Complete Market Case.

Just as in section 3.2, for a more general utility function uₖ the following algorithm is what should actually be applied in order to avoid having to recursively calculate \vec{α} and \vec{Δ}.
Determine \vec{Ω} by solving a tractable version of:

$${max}_{\vec{Ω} ϵ A} ( {\sum }_{k = 1}^{{N}_{T}} {e}^{- {r}_{k} {T}_{k}} {E}_{Q} [ {u}_{k}^{- 1} ( {E}_{P} [ {u}_{k} ( {π}_{k}^{\vec{Ω}} + {ϵ}_{k}^{\vec{Ω}} ) \vert F ( {T}_{k} ) , {L}_{k}^{\vec{Ω}} ] ) \vert F ( 0 ) , {L}_{1} ] )$$

Find \vec{α} and \vec{Δ} by solving:

$$\begin{matrix}{max}_{\vec{α} ϵ A , \vec{Δ}} {c}_{0} {u}_{0} ( χ ) + {\sum }_{k = 1}^{{N}_{T}} {e}^{- {r}_{k} {T}_{k}} {E}_{P} [ {c}_{k} {u}_{k} ( {π}_{k}^{\vec{α}} + {ϵ}_{k}^{\vec{α}} + {\int }_{0}^{{T}_{k}} {e}^{{r}_{k} ( {T}_{k} - τ )} {Δ}_{k} ( r ) {dF}^{′} ( τ ) ) \vert F ( 0 ) , {L}_{1} ] & ( 25 ) \\ where & \\ χ = {\sum }_{k = 1}^{{N}_{T}} {e}^{- {r}_{k} {T}_{k}} {E}_{Q} [ {u}_{k}^{- 1} ( {E}_{P} [ {u}_{k} ( {π}_{k}^{\vec{Ω}} + {ϵ}_{k}^{\vec{Ω}} ) \vert F ( {T}_{k} ) , {L}_{k}^{\vec{Ω}} ] ) \vert F ( 0 ) , {L}_{1} ] - {\sum }_{k = 1}^{{N}_{T}} {e}^{- {r}_{k} {T}_{k}} {E}_{Q} [ {u}_{k}^{- 1} ( {E}_{P} [ {u}_{k} ( {π}_{k}^{\vec{α}} + {ϵ}_{k}^{\vec{α}} ) \vert F ( {T}_{k} ) , {L}_{k}^{\vec{α}} ] ) \vert F ( 0 ) , {L}_{1} ] . & \end{matrix}$$

Implement operating strategy Q in the real-world operations and the trading strategies: [Δₖ+Δₖ^{\vec{α}}−Δₖ^{\vec{Ω}}] for all k=1, . . . , N_{T} in the financial markets.

### 1.6. Transaction Costs and Continuous Trading.

No financial market is perfectly frictionless, and whenever a hedging strategy requires re-balancing a portfolio infinitely often, even the smallest transaction cost would lead to huge losses. Despite these facts the assumptions of frictionless and continuous trading are used widely in the derivatives finance literature and are successfully used throughout the multi-trillion dollar derivatives industry to get the correct prices. The reason why the assumption of frictionless trading gives rise to accurate results in practice lies partly in the way in which sell-side derivatives firms organize their portfolios and thereby help facilitate the derivatives dealings of other firms.

Sell-side derivatives firms represent the portion of the financial industry involved with the creation, promotion, analysis and sale of derivatives. Such firms buy derivatives from clients at slightly less than market value and/or sell derivatives to other clients at slightly more than market value. The reason such transactions don't violate no-arbitrage considerations is that hedge re-balancing transaction costs prohibit these clients from implementing their own delta-hedges directly, while the special structure of the derivatives portfolio of trades held by the sell-side firm drastically reduces or eliminates these costs from their perspective. Sell-side firms consistently try to maintain a balanced derivatives portfolio that is long risk factors with some clients and short the same risk factors with other clients. In doing so the overall hedging requirements for the derivatives portfolio as a whole are reduced. Some mismatching of risks is still bound to occur, and this will require that a delta-hedging approach be applied to hedge just this residual amount. The hedging of this residual risk will inevitably be subject to some transaction costs, however the size of these hedges should be small relative to the overall size of the portfolio of client trades, and the amounts charged to clients should be more than enough to cover such transaction costs. If this were not the case, sell-side firms could not make a profit. Competition between sell-side firms ultimately reduces margins and pushes derivatives prices towards their theoretical frictionless values. Transaction costs can be reduced further by continuously monitoring the derivatives portfolio, but only re-balancing discretely often as determined by the traders. Such discrete re-balancing can lead to tracking errors between a given derivative instrument and its replicating hedge, which in turn can cause the replicating hedge to be higher or lower in value relative to it's corresponding derivative. However, with a large and well balanced portfolio, the over-hedging of some contracts will be balanced off by the under-hedging of others so that the tracking error on the portfolio as a whole will be far less than the sum of the tracking errors of the individual trades.

For the reasons listed above the mathematical assumption of fictionless trading is necessary to approximately get the correct value when pricing individual derivatives contracts. Because of these portfolio effects, sell-side derivatives firms such as Morgan Stanley that engage in both the physical commodity business and the financial derivatives business (see Arnsdorf (2012) for example) will therefore have little trouble in implementing dynamic hedging strategies for themselves or on behalf of their clients. Similarly, commodity production/conversion firms that also have sell-side derivatives trading arms such as Cargill Inc. or Koch Industries, will also be able to implement dynamic hedging strategies even in markets with frictions. In fact, for such firms the existence of some transaction costs in the derivatives markets may constitute a net source of profit from the resulting higher fees that can be charged on client trades.

For other firms however a dynamic hedging strategy may be more problematic in a market with frictions, and so such firms may either need to partner with sell-side derivatives firms or include other types of derivatives in their hedging strategies. Consider for example a commodity producer that produces a given quantity of some commodity each month, provided the market price is greater than the cost of production. In that case the producer's cash-flows are equivalent to those of a series of monthly call options with a strike price equal to the production cost. Consequently, rather than implementing a dynamic delta-hedging strategy, a simpler strategy would be just to sell call options. By selling the same number of financial options, with the same strike, as they have real-options, the firm could completely eliminate all risk without the need to dynamically, continuously re-hedge, thus avoiding the associated re-balancing costs. In reality operational constraints may mean that the real and financial contracts may not be perfectly matched, which would require that the residual risk be delta-hedged. However this residual risk will be much smaller and would therefore result in far fewer transaction costs as compared to dynamically hedging the entire exposure. Risks can also be matched more closely with the use of more advanced hedging strategies that include both standard financial options contracts as well as structured financial products such as: physical asset leases, power-tolling agreements, structured commodity lease agreements, gas-storage contracts, or swing-options (see Eydeland and Wolyniec (2003)) that are designed specifically to match the risk profiles of the physical assets they are meant to hedge.

Later in Example III sections 3.2.3, 3.2.4 and 3.2.6 we will also introduce another type of structured financial product that can be used to facilitate Ghost-path strategies without so any transaction costs.

It should be noted that the algorithm listed above assumed that the hedges were done using forward contracts, but this was done for simplicity of exposition only. In fact any derivative contract with the same set of risk-factor sensitivities can be used and are covered by this patent.

### 2. Example II Ship Routing a Numerical Example

This section applies the Ghost-Path hedging idea to the case of stochastic vessel routing in the presence of a forward freight rate market.

### 2.1. A Four-Port Network Example.

In this section, we provide a numerical example of the proposed model. The goal of this numerical experiment is to examine the impact of the profit enhancement of the ghost-path methodology over traditional OM techniques in a realistic setting, and to examine how the profit enhancement varies with profit margins. To do this we utilize empirical freight rate data to determine the correct stochastic model that describes the data and we use an approximate dynamic programming method to illustrate the ghost-path hedging theory. We do this using an imaginary network roughly based on several major trade routes in the real world.

Consider a shipowner operating a single vessel on a four-port network as shown in FIG. 7. Ports A and C are importing nodes which serve as destinations for cargo but do not export any goods, and therefore have no demand for freight. In contrast, ports B and D are exporting nodes, each with cargo awaiting to be shipped to either port A or C, but do not import any cargo. A voyage from an importing node to an exporting node is a ballast leg which, for the purpose of the study, and generates no revenue (but may incur costs).

We assume that the spot and forward freight rates of each route are given by the quotes, in $/ton, of the respective Baltic Capesize routes (C3, C4, C5 and C7) and the one-way voyage time for each route is as indicated in the figure.

2.2. State Space and Empirical Freight Rate Dynamics. We consider a planning horizon of 1 year, discretized into weekly decision times t=0, . . . , T₅₂. The physical state space consists of all the possible locations that a vessel in the network may be at the end of each week. If a vessel is partway through a leg of a journey, it is assumed that no option to switch routes is allowed. In other words the vessel must complete a route before the choice of another route is allowed. In addition to these states we include a temporary lay-up state (with a cost of $75,000/week) and a permanent abandonment state from which no other states are accessible.

With most forward curves, the volatility and correlations between forward contracts varies with the time to maturity. To model this time dependence we make the standard string model assumption that volatilities and correlations are piecewise constant in the number of months to maturity, a choice driven by the monthly nature of forward curve data. So that if a given forward contract expires sometime between 11 and 12 months from today it has one volatility, and a month later it may have a different volatility. If we let lₖ(t) represent the number of months until the k^{th} forward delivery period given the current time t then assuming a lognormal forward curve model, we have the following set of SDEs for the risk neutral dynamics of the forward curves:

$$\frac{{dF}_{i} ( t , {T}_{k} )}{{F}_{i} ( t , {T}_{k} )} = \{ \begin{matrix}{σ}_{{il}_{k} ( t )} {dZ}_{ik} ( t ) & for t \leq {T}_{k} \\ 0 & for t > {T}_{k}\end{matrix} for i = 1 , … , 4 , k = 1 , … , 52.$$

The function lₖ(t) is also referred to as the promptness of forward delivery period k. The correlations between each of the stochastic processes was also assumed to be piecewise constant in lₖ(t). The forward prices for the ballast legs where all assumed to be zero.

Using the historical forward freight rate data for the Baltic Capesize routes C3, C4, C5 and C7 over the 18-month period from July 2010 to December 2011, the relative volatilities of the freight rates for each route as a function of the number of months to maturity (promptness), was estimated. FIG. 8 plots the volatility by promptness of each route, while FIG. 9 shows the correlation among different routes and contracts of different promptness.

In the correlation plot (FIG. 9), we see that the prices of prompt contract across all routes are highly correlated; in general, correlation among contracts decreases with difference in promptness. Correlation across routes are highest in the pairs C3 & C5, and C4 & C7, while other route pairs remain moderately correlated. A key observation is that the correlations between different points on the same forward curve are very far from perfect. Hence using a single stochastic process to model an entire forward freight curve cannot be justified from this empirical data.

### 2.3. Standard OM Versus Ghost-Path.

Next we examine the impact of converting a standard OM optimized strategy into an equivalent ghost-path enhanced approach. Standard OM models for vessel routing typically optimize using an expert forecast of future prices and then determine the optimized routing schedule based on this forecast. For simplicity we will use the actual prices as they occurred over the year starting June 2010, as the forecast for the standard OM approach.

To calculate the market value maximizing strategy n required to implement Theorem 1, we must solve a very high-dimensional stochastic dynamic optimization recursion. Let W(Lₖ,F(Tₖ),Tₖ) be defined as the maximum market value (as defined in definition 3) of the sum of the remaining operational payoffs from time Tₖ to time T_{N}_{_{T}}, given the state of the operation Lₖ, and the state of the financial market F(Tₖ) at time Tₖ. Then the dynamic programming recursion becomes:

$$W ( {L}_{k} , F ( {T}_{k} ) , {T}_{k} ) = {max}_{{Ω}_{k} ϵ𝒜} ( {π}_{k} ( {Ω}_{k} , {L}_{k} , S ( {T}_{k} ) ) + {e}^{- {r}_{k} ( {T}_{k + 1} - {T}_{k} )} {{E}_{Q} [ W ( {L}_{k} + {Ω}_{k} , F ( {T}_{k + 1} ) , {T}_{k + 1} ) ]}_{t = {T}_{k}} ) . \qquad ( 26 )$$

To solve the above equation we employ an approximate dynamic programming algorithm similar to that of Longstaff and Schwartz (2001). In this algorithm paths of the risk neutral dynamics for all curves at all decision periods are simulated. Then starting from the end of the planning horizon and working backward, for every possible operating state the optimal decision is approximated by regressing all of the simulated payoffs corresponding to any given decision Ωₖ, against a polynomial approximation for the function E_{Q}[W(L(Tₖ)+Ωₖ,F(Tₖ₊₁),Tₖ₊₁)]_{t=T}_{ₖ} for each decision Ωₖ. Comparing the approximations for every feasible decision Ωₖ, the optimal decision at time Tₖ for each scenario and for each operating state is determined from equation (26). The payoffs associate with the decisions for each scenario, and for each state, are then updated using the price as realized in each scenario. In other words the polynomial approximation is only used to determine the operating decisions not the expectations arising from the decision. This processes is then repeated backward in time for each time-step until Tₖ=0.

FIG. 10 shows the actual realized profit, using actual market data, from employing the standard OM strategy as well as the equivalent ghost-path enhanced strategy, over a range of weekly voyage cost values. This plot clearly shows a significant increase in realized profit from employing the ghost-path enhanced version. It should be noted that this improved profit comes with no increase in market risk.

Note that for the standard OM strategy, the profit decreases monotonically with cost. Interestingly however, the same is not true of the dominant version of the OM strategy. The increase in profit for costs in the $2.8-3×10⁵ range is due to a significant drop-off in the value of E_{Q}[πₖ^{\vec{α}}(Tₖ)]ₜ₌₀. In other words, initially the market believes management's preferred routing strategy to be far less attractive in those cost regimes. Since the profit increase in the ghost-path enhanced case is E_{Q}[πₖ^{\vec{Ω}}(Tₖ)]ₜ₌₀−E_{Q}[πₖ^{\vec{α}}(Tₖ)], a lower E_{Q}[πₖ^{\vec{α}}(Tₖ)]ₜ₌₀ results in a higher profit to the firm. Hence ghost-path hedging can sometimes lead to “spooky” behavior whereby profit can rise with costs all else being equal, whenever the market implied operating strategy is significantly different from management's own preferred operating strategy given their views of the future and appetites for risk.

FIG. 11 shows that the percent improvement of the ghost-path enhanced strategy over the standard OM strategy, ranges from a low of 11% when costs are low and profits are high, to nearly an 1100% improvement when costs are high and margins are tight. These two graphs would indicate that the ghost-path enhanced strategy can lead to dramatic profit is increases over standard OM strategies without taking on any additional risk.

### 3. Example III: Ghost-Path Hedging and Cut-Off Grade Mining Models

This section applies Ghost-Path hedging techniques to general mining problems. We begin by describing the cut-off decisions faced by all types of mining operations. We describe a simple set-up that is commonly used in both mining theory and practice. We then show how Ghost-Path techniques can improve mining results. We use real data from the Detour-Lake mine to illustrate the power of Ghost-Path Hedging. We also discuss alternative structured financial products that can be used to facilitate the types of hedges required in convenient ways. And we discuss other extensions to more detailed versions of the cut-off problem.

### 3.1. Modeling the Physical Operation: Mono-Metallic Open Pit Case.

We start by introducing a typical operational model for a mine. We begin by defining the key variables of the problem. The notation we will use closely maps with that of Thompson and Barr (2014) however we will employ a discrete rather than continuous phase distribution, similar to what is more commonly seen in practice. In general a mine is excavated in a series of phases. Within each phase the geo-statistical properties of the mine will be unique to that phase. Let I be the current size of the total deposit (ore+waste) remaining and n be the total number of phases in the mine design. Then let j(I) be a function mapping [0,Iₘₐₓ]∪R→[1, 2, . . . , n] C N that determines the current phase number given a value of I where Iₘₐₓ is the total amount of material contained initially in the overall mine. In general the geology within each phase varies and so by introducing the variable j(I) we can model the different geostatistical properties of the mine, and how they vary from one-phase to another.

Any volume of rock within a given phase can be classified by it's fraction of recoverable metal content. This fraction is referred to as the recoverable grade of the rock. Let g be the recoverable grade of a given piece of rock (i.e. if g=0.05 then 5% of the rock, if processed, could be turned into metal). Furthermore let PD_{j(I)}(g) be the phase distribution: the total amount of rock in phase j(I) with recoverable grade g. Phase distributions given in histogram form are direct outputs of standard mine design software (such as SURPAC). An example of a phase distribution histogram for the Detour Lake gold mine can be see in FIG. 12. This figure shows for example that there are approximately 675,000 tonnes of material that contain 0.3 grans per tonne of gold. Similarly, there is approximately 180,000 tonnes of material with 1 gram of gold per tonne. Therefore in this case PD_{j(I)}(0.3)=675,542 and PD_{j(I)}(1)=178,187.

The grade tonnage histogram also shows the average grade of the material that is above the cut-off. For example if the cut-off grade is 0.3, then the average grade of material with at least 0.3 grams of gold per tonne of material is approximately 0.81. Similarly, if the cut-off grade is set at 1.0, then the average grade of the material that satisfies this minimum is 1.58. If Av_{j(I)}(g) represents the average grade of material with at least g units of metal per tonne of material, in phase j(I), then in this example Av_{j(I)}(0.3)=0.81 and Av_{j(I)}(1)=1.58.

The cut-off c is defined such that if a unit of rock contains metal grade fraction g then if g≥c the rock is considered ore, otherwise it is considered waste. Thus c is the point that delineates the distinction between ore and waste. The total amount of ore O(I,c) in phase j(I) is therefore given by

$$O ( I , c ) = {\sum }_{g \geq c} {PD}_{j ( I )} ( g ) tonnes \qquad ( 27 )$$

and the total amount of waste W(I,c) in the phase is

$$W ( I , c ) = {\sum }_{g < c} {PD}_{j ( I )} ( g ) tonnes . \qquad ( 28 )$$

The stripping ratio of waste-to-ore SR(I,c) is then given by

$$SR ( I , c ) = \frac{W ( I , c )}{O ( I , c )} . \qquad ( 29 )$$

If Kₘᵢₙₑ and K_{proc} the maximum mining and processing constraints respectively (measured in tonnes per year) then the resource depletion rate (the rate at which I decreases) measured in years is given by:

min(K_{proc}(1+SR(I,c)),Kₘᵢₙₑ). (30)

To understand equation (30) suppose the stripping ratio SR was 2. Then two units of waste are extracted for every one unit of ore, so the maximum rate that we could extract material from the deposit before hitting the processing constraint would be 3K_{proc}. If this value was greater than the mining constraint Kₘᵢₙₑ then Kₘᵢₙₑ would determine the extraction rate.

Typically in cut-off optimization practice, the time dimension is discretized as: t₀, L₁, . . . , tₖ, . . . T_{N} and a cut-off value is determined for each time interval. Let c=[cₜ_{₀}, cₜ_{₁}, . . . , Cₜ_{_{N}}] be the vector consisting of the cut-off value to be employed during each time period. Once the vector c is specified all of the physical states of the mining system flow from c deterministically. For example, if Iₜ_{ₖ}(c) represents the amount of material remaining to be mined at time tₖ, and if Eₜ_{ₖ}(c) represents the rate of material extraction at time tₖ, and if tₖ=tₖ₊₁−tₖ represents the length of time interval k then:

Exₜ_{ₖ}(c)=min{Iₜ_{ₖ}(c),min(K_{proc}(1+SR(Iₜ_{ₖ}(c),cₜ_{ₖ})),Kₘᵢₙₑ)δtₖ} (31)

and

$${I}_{{t}_{k}} ( c ) = {I}_{max} - {\sum }_{i = 0}^{k} {Ex}_{{t}_{i}} ( c ) . \qquad ( 32 )$$

Equation (32) states that the amount of material remaining at time tₖ is just the sum of the amounts extracted during all previous time periods. The extraction rate equation (31) is made up of a composition of two min functions. The inner min function consists of the extraction rate definition from equation (30) scaled by the length of the time interval t. The outer min function ensures that there cannot be more material extracted than there is remaining in the deposit, and ensures that Iₜ_{ₖ} is always non-negative.

The quantity of metal produced during time interval tₖ is also completely determined by the choice of c. The quantity produced is simply the product of the processing rate of the material classified as ore multiplied by the average recoverable grade of ore, in other words the quantity Qₜ_{ₖ}(c) of metal produced at time tₖ is given by:

$${Q}_{{t}_{k}} ( c ) = \frac{{E}_{{t}_{k}} ( c )}{1 + SR ( {I}_{{t}_{k}} ( c , {c}_{{t}_{k}} ) )} {Av}_{j ( I ( c ) )} ( {c}_{{t}_{k}} ) . \qquad ( 33 )$$

The total costs incurred in time interval tₖ is also fully determined by the choice of c. Total costs are composed of three components: extraction/mining costs, processing costs and fixed costs. If we let the cost of extraction be denoted by Cₘᵢₙₑ dollars per tonne per year and the cost of processing be denoted as C_{proc} dollars per tonne per year, the fixed cost be represented as C_{fized} per year, then the total cost incurred at tₖ is given by:

$${Cost}_{{t}_{k}} ( c ) = {C}_{mine} Ex ( {I}_{{t}_{k}} ( c ) , {c}_{{t}_{k}} ) + {C}_{proc} \frac{Ex ( {I}_{{t}_{k}} ( c ) , {c}_{{t}_{k}} )}{1 + SR ( {I}_{{t}_{k}} ( c , {c}_{{t}_{k}} )} + {C}_{fixed} δ {t}_{k} . \qquad ( 34 )$$

Given the definitions presented above, we can now specify the objective function criteria for determining an optimal cut-off strategy c.

### 3.1.1. Standard Approach to Cut-off Optimization.

The industry standard methodology for determining the cut-off strategy which ultimately specifies the entire production process of the mine, is a discounted cash-flow maximization. The standard approach starts by determining a (possibly risk-adjusted) forecast of metal prices, along with an appropriate set of discount factors to adjust for risk, the cost of capital, and the time-value of money. Let P=[Pₜ_{₀}, Pₜ_{₁}, . . . , Pₜ_{_{N}}] be any price forecast for the price in each time period tₖ. Let D=[dₜ_{₀}, dₜ_{₁}, . . . , dₜ_{_{N}}] be the set of continuous-time discount factors for each time interval tₖ such that the present value of $1 at time tₖ is

$${e}^{- {d}_{{t}_{k}} {t}_{k}}$$

Given any choice of cut-off strategy c the estimated present value of the mine can be written as:

$$W ( c ; P , D ) = {\sum }_{k = 0}^{N} {e}^{- {d}_{{t}_{k}} {t}_{k}} ( {P}_{{t}_{k}} {Q}_{{t}_{k}} ( c ) - {Cost}_{{t}_{k}} ( c ) ) . \qquad ( 35 )$$

The standard way for determining the cut-off strategy that the mine will employ, is to find the value of c that maximizes equation (35), given management's risk-adjusted forecast of future prices P and their risk-adjusted discount rates D. Let c^{α} denote the value of c that solves the dynamic optimization problem:

$${max}_{c} W ( c ; P , D ) .$$

The standard cut-off strategy employed by mining firms today is c^{α}.

### 3.2. Ghost-Path Approach Applied to Cut-off Grade Optimization.

### 3.2.1. Overview.

In order to describe the Ghost-Path hedging approach as it relates to the cut-off optimization problem, we need to introduce some notation for the forward prices of a metal (or oil in the case of oil-sands mining). In order to specify a forward price, two separate time variables are needed, one to represent the time at which the price was observed, and another to represent the delivery period to which that the particular forward refers. Let F(t,T) represent the forward price of the relevant commodity observed at time t for delivery at time T. If at time t=0 one entered into a forward contract to purchase one unit of the commodity(s) at time T, then the pay-off of such an agreement at time T would be given by: F(T,T)−F(0,T). The value F(T,T) represents the final settlement or spot price of the commodity at time t=T and is an unknown random quantity at time t=0. The formula F(T,T)−F(0,T) therefore represents the difference between what the commodity ultimately is worth at time t=T and the agreed upon delivery price originally negotiated at time t=0. By cost-of-carry arbitrage the forward price today (time t=0) for delivery at time Tₖ, F(0,Tₖ) is given by:

$$F ( 0 , {T}_{k} ) = {Se}^{( {r}_{{T}_{k}} + {u}_{{T}_{k}} - {c}_{{T}_{k}} ) {T}_{k}} \qquad ( 36 )$$

where S is the current spot price, u_{T}_{ₖ} is the proportional storage cost and c_{T}_{ₖ} is the convenience yield (see Hull (2012)). We know the relationship in equation (36) must be true because if

$$F ( 0 , {T}_{k} ) < {Se}^{( {r}_{{T}_{k}} + {w}_{{T}_{k}} - {c}_{{T}_{k}} ) {T}_{k}}$$

then an arbitrageur could make free money by borrowing the commodity today, selling it at today's price, investing the proceeds in a risk free bond, while at the same time paying the cost of borrowing (convenience yield minus the storage cost) and using the forward contract to replace the borrowed commodity at time Tₖ. If

$${T}_{k} . If F ( 0 , {T}_{k} ) > {Se}^{( {r}_{{T}_{k}} + {u}_{{T}_{k}} - {c}_{{T}_{k}} ) {T}_{k}}$$

then the reverse of the aforementioned trade could also be used to make free money. With this notation in hand, we can describe the Ghost-Path hedging technique as it applies to cut-off grade theory.

Ghost-path hedging argues that whenever some or all of a firm's risk factors are spanned in the financial markets, management's appetites for risk (discount factors) or their views of the future (price forecasts) for those risk factors, no matter how prescient they may be, should never enter into their physical operations management strategy. Instead these crucial considerations should be addressed in the firm's financial trading activities and the way to accomplish this is through the use of the so-called Ghost-Path hedge. A Ghost-Path hedge requires that two separate copies of the same physical operation must be modeled in order to determine both an operating strategy and an associated hedge. According to this theory there are at least three components that management should undertake. The first component is to determine the operating strategy that maximizes the current market value of the operation as implied from the prices in the financial forwards market while using the risk-free zero curve to discount future cash-flows, and to implement this strategy in the firm's physical operations. For mine managers, this means that the cut-off strategy that is actually implemented should be determined using the risk-free discount rate, and a price forecast that matches the current forward curve i.e. the price forecast P used in equation (35) should have individual components

$${P}_{{t}_{k}} = F ( 0 , {T}_{k} ) = {Se}^{( {r}_{{t}_{k}} + {u}_{{t}_{k}} - {c}_{{t}_{k}} ) {t}_{k}}$$

and the discount factors D should have individual components

$${e}^{- {r}_{{t}_{k}} {t}_{k}} .$$

Next, the second component is to implement a financial hedge that would lock-in the value of the first component. This would mean selling the planned quantities of production (Qₜ_{ₖ} for all k) resulting from this cut-off strategy into the forward market. Lastly, the utility maximizing operations management strategy (i.e. the cut-off strategy management believes to be optimal) is determined, and the third component is to implement the reverse hedge corresponding to an imaginary contingent claim on the payoffs 2s of this utility maximizing operating strategy. Imaginary in this case refers to the fact that the operating strategy used to determine this hedge (management's preferred cut-off choice) is never actually implemented in the real-world and doesn't correspond to any actual asset. Applied to the cut-off grade problem, this would just mean calculating optimal cut-offs using the current standard practice, incorporating all of management's forecasts, risk-preferences, discount-rates, and cost-of-capital constraints, and buying the resulting production plan from the forward market. Of course the two aforementioned hedges greatly off-set one another, the first involves selling forward the second involves buying forward, so it's only the net result of these two hedges that one must actually implement. The closer the two cut-off strategies are to one another the less hedging is necessary. It was shown in Thompson et al. (2017) that this this three step process is guaranteed to dominate the standard approach (i.e. it always results in higher profits under all possible future price paths, as compared to implementing the standard utility-maximizing cut-off strategy physically). In this section we will also re-derive the dominance of the proposed Ghost-Path implementation over the current industry standard approach in the case of deterministic cut-off grade optimization.

### 3.2.2. Mathematical Description.

Let R=[rₜ_{₀},rₜ_{₁}, . . . , rₜ_{_{N}}] be the vector of risk-free, zero coupon discount factors under continuous compounding, that applies for each time period tₖ, and let F=[F(0,t₀), F(0,t₁), . . . , F(0,t_{N})] be the vector of forward prices observed at time t=0 for delivery at each of the relevant time periods tₖ. For simplicity we will assume a single product output and deterministic production costs. Extensions to multiple price/cost forward curves is a simple extension and is included in the general theory presented in section 3.2.4. Let c^{Ω} be the cut-off strategy that solves:

$${max}_{c} W ( c ; F , R ) .$$

Assume that:

W(c^{Ω};F,R)>W(c^{α};F,R). (37)

Recall that c^{Ω} was chosen to maximize the NPV of the mine where the price forecast was given by the forward curve F with discount factors given by the risk free zero curve R, whereas c^{α} was chosen to maximize the NPV of the mine given management's forecasts of future prices P and their own risk adjusted discount curve D. So unless F:=P and R=D it is very unlikely for W(c^{Ω};F,R)=W(c^{α};F,R) and by the definition of c^{Ω} it is impossible for W(c^{Ω};F,R)<W(c^{α};F,R).

The new proposed operating/trading strategy therefore is to implement cut-off strategy c^{Ω} and simultaneously enter into forward contracts in the amount: (Qₜ_{ₖ}(c^{α})−Qₜ_{ₖ}(c^{Ω}) for each time period tₖ for k=0, . . . N. The payoff of this strategy at time tₖ is therefore given by:

F(tₖ,tₖ)Qₜ_{ₖ}(c^{Ω})−Costₖ(c^{Ω})+(F(tₖ,tₖ)−F(0,tₖ))(Qₜ_{ₖ}(c^{α})−Qₜ_{ₖ}(c^{Ω})). (38)

Equation (38) is comprised of the sum of three parts. The first part represents the revenue generated by the mine at time tₖ under cut-off strategy c^{Ω}, this component depends on the ultimate price F(tₖ,tₖ) of the commodity at time t=tₖ, which at time t=0 is an unknown random quantity. The second part of this equation represents the cost at time tₖ associated with cut-off strategy c^{Ω}. The last part of the above equation represents the payoff from the financial hedge. Equation (38) simplifies to:

F(tₖ,tₖ)Qₜ_{ₖ}(c^{α})+F(0,tₖ)Qₜ_{ₖ}(c^{Ω})−F(0,tₖ)Qₜ_{ₖ}(c^{α})−Costₜ_{ₖ}(c^{Ω}). (39)

In comparison, the payoff at time tₖ from implementing the standard cut-off strategy approach c^{α} is given by:

F(tₖ,tₖ)Qₜ_{ₖ}(c^{α})−Costₜ_{ₖ}(c^{α}). (40)

Notice that the coefficient in front of the uncertain commodity price F(tₖ,tₖ) in both equation (39) and equation (40) is exactly the same. Hence both strategies give rise to exactly the same commodity price exposure!

The difference between the payoffs of the new strategy and those of the standard cut-off strategy at time tₖ, can be found by subtracting equation (40) from equation (39) and once simplified, this difference is given by:

(F(0,tₖ)Qₜ_{ₖ}(c^{Ω})−Costₜ_{ₖ}(c^{Ω}))−(F(0,tₖ)Qₜ_{ₖ}(c^{α})−Costₜ_{ₖ}(c^{α})). (41)

A key observation about equation (41) is that the dependence on the uncertain quantity F(tₖ,tₖ) has been eliminated. Every term in equation (41) therefore, is completely known with certainty as of time t=0. Therefore the correct discount factor appropriate for determining the NPV of this difference would be the risk-free discount factor e^{-r}^{ₖ}^{t}^{ₖ}. Summing the NPV of the difference in payoffs between the new approach and the standard approach, over all time periods tₖ for k=0, . . . , N equals:

$$( {\sum }_{k = 0}^{N} {e}^{- {r}_{k} {t}_{k}} ( F ( 0 , {t}_{k} ) {Q}_{{t}_{k}} ( {c}^{Ω} ) - {Cost}_{{t}_{k}} ( {c}^{Ω} ) ) ) - ( {\sum }_{k = 0}^{N} {e}^{- {r}_{k} {t}_{k}} ( F ( 0 , {t}_{k} ) {Q}_{{t}_{k}} ( {c}^{α} ) - {Cost}_{{t}_{k}} ( {c}^{α} ) ) )$$

which by definition is:

W(c^{Ω};F,R)−W(c^{α};F,R) which by equation (37)>0.

This means that compared to the standard approach to cut-off grade optimization, the new approach is guaranteed to result in higher profits no matter what the ultimate commodity prices turn out to be. Not only that but the amount by which the profits are increased is known exactly at time t=0 the moment the cut-off strategy is decided upon and the financial hedge is implemented. So that although we cannot say for certain exactly what the final profits will turn out to be, we can tell exactly how much better off the mine is under the new proposed cut-off/trading strategy as compared to the current standard methodology. In addition, the trading strategy for this type of cut-off optimization, is a static hedge. Management needs only implement the trade once and doesn't have to continually re-balance their financial portfolio, the way they would if they were hedging an option for example. This makes the implementation far easier than most other financial trading strategies with far lower transaction costs.

In the above we compared a strategy that combined both a physical cut-off component and a financial trading component, to that of the standard cut-off grade theory that considers only the physical cut-off component in isolation. A natural question therefore might be: is there another financial strategy that when added to the standard cut-off approach, re-establishes the optimality of the standard theory? Any financial strategy that management can think of to add to their current cut-off plan could just as easily also be added to the new proposed approach. Hence when comparing the differences between the two implementations, exactly the same profit enhancement would result no matter what other trading strategy was added to both approaches. Therefore any cut-off/trading strategy management wishes to implement must include the hedging strategy proposed here as a sub-component or their decisions won't be optimal.

Another advantage of the proposed methodology, is that its implementation doesn't require any new additional models or software. The same software used today to calculate cut-off strategies can be re-used in the new approach. All that is needed is for the model to be run twice: once using the forward prices as the forecast and the risk-free rates as the discount factors, and a second time using management's actual forecast and actual discount rates, and then to combine the outputs of these two runs in the correct manner as detailed above.

### 3.2.3. Alternative Financial Structured Products.

In the above, forward contracts were used as the basis for the financial strategy. This has the advantage that the mathematics is easy to demonstrate, and it also has the benefit of being able to implement using existing, standard off-the-shelf mining engineering software. However, there are other financial products that can provide the same results that may be more intuitive to understand or more practical to implement. For example, any structured financial instrument such as a variable notional commodity swap, could also be used to achieve the same results so long as the commodity price sensitivity of the instrument in each time period tₖ was (Qₜ_{ₖ}(c^{α})−Qₜ_{ₖ}(c^{Ω})). A more intuitive way of understanding the Ghost-Path hedging technique, and perhaps a more convenient financial structure for implementing this methodology, might be a modified version of a commodity leasing agreement.

Consider a gold mine whose cost-of-capital and risk tolerances were such that it preferred to discount uncertain future cash-flows at a rate higher than the risk-free rate. All else being equal, in this case the mine would prefer to use higher cut-off values then it would use if its own discount factors were the risk-free rates. This is because the higher cut-off values would bring more of the future cash-flows forward in time where they would be more valuable to the firm. The quantity that management wishes to produce at time tₖ, to maximize their utility is given by: Qₜ_{ₖ}(c^{α}) but the quantity that management should actually produce according to the theory presented here is given by: Qₜ_{ₖ}(c^{Ω}). Initially, for small tₖ values Qₜ_{ₖ}(c^{α})>Qₜ_{ₖ}(c^{Ω}) so the firm would have to borrow the difference in gold to meet this production shortfall. For later time periods tₖ, Qₜ_{ₖ}(c^{α})<Qₜ_{ₖ}(c^{Ω}) so the mine could pay-back the borrowed gold with the resulting future over-production. Because of this lower cut-off strategy less waste will ultimately be produced under this new paradigm, meaning that the mine will now be producing gold that under standard cut-off theory would otherwise have been wasted. A gold leasing agreement that allowed the mine to borrow gold from long-term gold investors, or pension funds, or a gold ETF, or a central bank, or a national government, at a pre-determined lease rate, would produce exactly the hedge management requires to implement the Ghost-Path technique. Initially all of the gold that otherwise would be wasted, less the amounts needed to pay the lease costs for the borrowed gold, would instead be borrowed and sold at spot. A portion of the proceeds would be invested in risk-free securities in an amount sufficient to cover the future costs of extracting and producing the gold required to payback the gold loans, and these securities along with the mine rights would be placed in escrow. A profit equal to the difference between the revenue of the sold gold and the amount in escrow would then be realized by the mine at time t=0. The mine would then operate and produce gold in the amounts according to the schedule Qₜ_{ₖ}(c^{Ω}) and additional gold in the amount Qₜ_{ₖ}(c^{α})·Qₜ_{ₖ}(c^{Ω}) would be borrowed (if Qₜ_{ₖ}(c^{α})>Qₜ_{ₖ}(c^{Ω})) or repayed (if Qₜ_{ₖ}(c^{α})<Qₜ_{ₖ}(c^{Ω})) over the remaining time frame to ensure the mine receives their utility maximizing production plan Qₜ_{ₖ}(c^{α}). Additional funds would then be added/subtracted from escrow as required to cover any future production costs resulting from any future gold borrowing/repayments. By the cost-of-carry arbitrage argument, so long as the agreed upon gold lease rate was used as the net convenience yield when constructing the forward curves, this type of product would be guaranteed to increase management's profit by an amount equal to W(c^{Ω};F,R)−W(c^{α};F,R) no matter what gold price path actually materializes. Furthermore since all of the borrowing/lending is done in gold rather than in any particular currency, this quantity has no interest rate or foreign exchange risk. And since the mine is always a net borrower in this case, there is no counter-party credit risk for the mine either.

From the perspective of the long-term gold investor(s), pension fund, gold ETF, central bank, or national government that leant the mine the required gold, they would ultimately still receive whatever capital gain they would have otherwise received had they simply placed their gold in a vault, plus the lease fees paid by the mine, plus they would be spared the cost of storing and securing the gold during the given time-frames. These profits also would be independent of interest rate or foreign exchange risk, however the lender would be exposed to the counter-party credit risk of the mine defaulting on their gold loan. The escrow account mentioned above, consisting of the mine rights and risk-free bonds sufficient to cover the future extraction/production costs of all remaining borrowed gold would eliminate this credit risk for the gold lender. If the mine defaulted at any time on their obligations, then the mineral rights to the gold still owed, and a cash account sufficient to cover the costs of producing that required gold, would revert to the lender, thereby ensuring the lender will always be compensated for any counter-party default. If the lender was a national government, the benefits to them would be even greater. The increase in profit resulting from the Ghost-Path hedging strategy described here and facilitated by this contract, would be taxable income, some of which the government would receive. In addition, by allowing the mine to operate at a lower cut-off level, less waste would result (more gold would be produced) hence the government would also receive higher royalties. And lastly, the lower cut-off values would also extend the life of the mine, providing more job years for employees, which would also increase future government tax revenues and decrease the cost of future social assistance.

Of additional significance, the structure of this type of leasing arrangement is such that no commodity is actually ever stored. Instead it is borrowed, instantly sold and then produced again at some future time. Hence such a structure could just as easily be used on commodities that are difficult or even impossible to store. Allowing investors to invest in commodities that otherwise would be impossible or very costly, while also facilitating higher profits for producers through Ghost-Path hedging. Since right from the start the commodity is sold at spot, the actual commodity need not be made available in the first place, only the cash equivalent is needed. All that such an agreement requires is for the lender to agree to be compensated in the commodity itself (or the cash equivalent value of the commodity) at the times of repayment.

All of the benefits described above are made possible by the fact that the current textbook cut-off grade theory, and industry cut-off grade practice is a dominated strategy. The new combined cutoff/hedging technique described here rectifies this error, thereby preserving wealth that otherwise simply would have been thrown away.

### 3.2.4. Extensions to Multiple Tradeable Risk Factors.

So far we have considered the price of a single output commodity as the only risk factor. In practice however there could be multiple mining outputs, and other risk factors could include mining fuel costs such as oil and electricity. All such risk factors however can be handled in exactly the same way as we did for the single risk factor. First, calculate and implement the cut-off strategy found by assuming the discount rates are the risk-free rate and the future prices of each risk factor are given by their forward curve. Then sell the corresponding mining output quantities into the forward market, while simultaneously buying the required future fuel quantities from the forward market. Next calculate management's optimal utility-maximizing preferred cut-off strategy using the industry standard approach incorporating all of management's price forecasts, risk-preferences, cost-of-capital constraints or any other financial considerations (the Ghost-Path strategy). Then simultaneously buy the mining output quantities resulting from this utility maximizing cut-off strategy from the forward market, while selling the necessary quantities of fuel needed to produce these outputs into the forward market (the Ghost-Path hedge). Of course only the net result of all of this forward buying and selling in each forward time interval need actually be implemented. It is a straightforward extension to the above to show that this overall strategy will be guaranteed to result in higher profits as compared to the current industry practice.

To modify the aforementioned structured lease agreement to account multiple outputs one simply only needs to borrow in multiple commodities. To modify the agreement to account for oil risk for example, the mining firm would simply place the portion of the escrow funds related to the future oil needs for extracting and repaying the borrowed output commodity, into a similar oil lease agreement with a shale-oil or oil-sands mining counter party. Oil mining firms also use cut-off strategies and therefore by lending an oil-mining company oil, the oil-mining company would be able to reduce their cut-off related waste as well in exactly the same manner. The oil-mining company therefore would likely be happy to pay an increased leasing fee for the borrowed oil if it meant a similar profit enhancement for them as well. This increased oil lease rate in turn could further reduce the future costs for the gold company and increase the size of the profit enhancement for the gold firm.

Electricity, is not mined and is therefore not subject to cut-off theory. However, so long as the power company has a cost-of-capital greater than the risk-free rate, they too may be happy to pay the gold company a higher “electricity lease rate” for the rights to move the power company's future profits associated with the gold company's future electricity demand, forward in time. In essence a structured electricity lease agreement such as the one described here, could be used to synthetically store the electricity needs of the gold mine, related to the future production of the otherwise wasted gold, for years into the future. Considering that it's currently physically impossible to store any large quantity of electricity, even for one millisecond, a structured electricity lease agreement can serve another useful purpose as well.

### 3.2.5. Extensions to Non-Tradeable Risk Factors.

Non-tradeable/hedgeable risk factors can also be incorporated into the analysis and the process for doing this is detailed in the fully general case in section 1. The only change is that when determining the optimal strategy c^{Ω} management's forecasts and risk preferences should only be used with regards to the non-tradeable risks. Things that can be hedged should be valued as if their future forecasted values were the same as their current forward curve values and the risk-free discount rate should apply to these factors. Essentially nothing else changes except for the fact that the profit enhancement produced by the Ghost-Path Hedge is no longer guaranteed under all possible future risk-factor realizations. All that is guaranteed is that management will be guaranteed to prefer (at t=0) the new cut-off/trading strategy combination over the current industry standard choice.

### 3.2.6. Extension to Stochastic Cut-off Decisions.

An obvious further extension would be to apply the proposed technique to stochastic cut-off grade problems for which management can dynamically change cut-offs in response to market price fluctuations as well as suspend operations temporarily or permanently if prices become unfavorable. The Ghost-Path theory presented in section 1 specifically addresses the stochastic case and stochastic cut-off grade models can be found in Johnson et al. (2010) and Thompson and Barr (2014). In the stochastic case the required hedges are no longer static like those considered in this paper, rather they must be dynamically readjusted in response to price fluctuations. However a simple change to the proposed new lease agreement financial structure could be made to facilitate such requirements. Instead of agreeing on a fixed schedule of borrowing and repaying the commodity, a flexible schedule could be used that would allow the mine to adjust borrowing/repayment times (within pre-agreed limits) in response to market prices. Such a structure would be similar to a line of credit except that instead of borrowing/repaying the loan in cash, the borrowing/lending would be done in the underlying commodity (or the cash equivalent value of the commodity at the times of repayment). Of course such flexibility may have to come with additional user fees to make it attractive to commodity lenders/investors. However compared to dynamically trying to re-balance a portfolio of OTC forward contracts, such a financial structure could save substantially on dynamic delta-hedge related transaction costs, since there would be no additional charges for changing the amounts borrowed/repayed. This would allow the firm to achieve the full benefits of real optionality in the general stochastic setting.

### 3.3. The Detour Lake Gold Mine.

The Detour Lake gold mine is located in northern Ontario Canada. In March of 2011 the Detour Lake Mineral Resource and Mineral Reserve Update was prepared and published in (BBA (2011)). Some geological and mineral data along with various technical parameters of the mine were made public along with the financial assumptions that gave rise to the mine's cut-off strategy. The actual mine design consisted of four different phases each with their own grade-tonnage and average-grade-above cut-off histograms. However, only a single, coarse, aggregate histogram was published. While this limits the accuracy of the analysis it also greatly simplifies the calculations. This data is shown in FIG. 12 and is summarized in table form below.

| | Grade | | |
|---|---|---|---|
| | above | | Gold |
| Cut-off | cut-off | Tonnage | Contained |
| (Au g/t) | (Au g/t) | (’000s) | (’000s oz) |
| 0.3 | 0.81 | 675,542 | 17,565 |
| 0.4 | 0.92 | 550,258 | 16,273 |
| 0.5 | 1.03 | 450,612 | 14,931 |
| 0.6 | 1.14 | 370,792 | 13,603 |
| 0.7 | 1.25 | 306,650 | 12,331 |
| 0.8 | 1.36 | 254,960 | 11,144 |
| 0.9 | 1.47 | 212,656 | 10,038 |
| 1.0 | 1.58 | 178,187 | 9,027 |

In addition the following technical parameters were supplied.

| Parameter | Value | |
|---|---|---|
| Total Tonnage | 2230 × 10⁶ | T |
| of material | | |
| Mining rate | 120 × 10⁶ | T/yr |
| Processing rate | 22.24 × 10⁶ | T/yr |
| Recovery rate | 91% | |
| Mining Cost | $174 | CAD/T |
| Processing Cost | $6.09 | CAD/T |
| Fixed Cost | $68 × 10⁶ | CAD/yr |
| Royalty | 2% | |
| Pre-Production | $1,099 × 10⁶ | (CAD) |
| Capital Cost | | |
| Pre-Production | 2 | yrs |

times remaining

Production was set to start 2 years forward and for the first 3 years afterward, the production and processing rates were reduced to 90%.

The company's valuation assumed a flat a gold price forecast of $935 CAD per ounce, and used a 5% discount rate to account for the firm's cost-of-capital/minimum-profit constraints. Due to the simplicity and coarseness of the data provided it is feasible to list the financial consequences of each cut-off choice given the financial assumptions and physical parameters. The following table summarizes these calculations. Based on this analysis, the optimal cut-off grade was found to be 0.5 grams per tonne.

| Cut- | | Gold | Variable Cost |
|---|---|---|---|
| off | Life | Production | (millions |
| (g/t) | (yrs) | (1000’s oz/yr) | CAD$/yr) |
| 0.3 | 34.31 | 478.24 | 232 |
| 0.4 | 28.23 | 541.69 | 257 |
| 0.5 | 22.99 | 605.02 | 288 |
| 0.6 | 18.90 | 662.73 | 324 |
| 0.7 | 18.58 | 614.09 | 309 |
| 0.8 | 18.58 | 558.09 | 292 |
| 0.9 | 18.58 | 502.69 | 278 |
| 1.0 | 18.58 | 451.73 | 268 |

In order to apply the proposed new cut-off/hedging technique to this problem some additional information is required. The actual price of gold at that time was approximately $1,648 CAD per ounce and the Canadian-dollar risk-free rates gave rise to the discount factors shown in FIG. 13. If a gold lease agreement, such as the one described in the previous section, was to be employed in order to facilitate the required hedges, then a lease rate would have to be negotiated OTC. It is impossible to know exactly what rate could have been negotiated at that time. However, we can get some idea of conservative assumptions by looking at the publicly available historical lease rates data. FIG. 14 displays this data.

The higher the lease rate that the mine agrees to pay, the more attractive the lease agreement is to gold lenders/investors. Looking at the data we see that the average annual lease rate was 0.393% and the maximum lease rate ever agreed to in the data was 0.561%. In order to get a conservative estimate of the amount by which the new proposed technique could have improved the Detour lake project, we considered four OTC lease rate scenarios. The first was if Detour lake agreed to pay the average lease value, the second was if they committed to pay the maximum lease value anyone had ever had to pay in this historical data, the third scenario assumed Detour Lake agreed to pay twice the average value and the final scenario had Detour Lake agreeing to pay twice as much as the maximum amount ever agreed to in the data set. In each case the counter party to the leasing agreement would ultimately receive whatever capital gain they would otherwise have received on their gold investment, they would avoid storage and security costs while their gold was on loan, and would receive a risk-free bonus return equal to the agreed upon lease rate paid in the form of additional gold.

The Ghost-Path technique was applied using each of the aforementioned lease rates to generate the forward curves, and we assumed that production costs will inflate at 2% per year. The results in every lease rate scenario was for Detour lake to physically implement the lowest cut-off grade for which there was data. It is important to note that cut-off levels should increase with lease rates (convenience yields) so the fact the optimal cut-off value was always 0.3 g/t (the lowest available in the histogram), means that the actual optimal cut-off in each scenario must have been a value somewhere outside of the range of geological data provided. Therefore without more geological data, the exact optimal cut-off and profit enhancements are impossible to estimate, so that the best we can do is provide a lower bound on the enhancement value for each scenario.

The Ghost-Path production plan (Qₜ_{ₖ}(c^{α})) along with the real production plan (Qₜ_{ₖ}(c^{Ω})) are shown in FIG. 15.

The table below summarizes the guaranteed amount by which the new proposed cut-off/hedging technique would enhance the mine's profit (i.e. the size of W(c^{Ω};F,R)−W(c^{α};F,R)) for each lease rate assumption.

| Annual Gold | | Profit |
|---|---|---|
| Lease Rate | | Enhancement |
| 0.393% | (mean) | $2.45 Billion |
| 0.561% | (max) | $2.31 Billion |
| 0.786% | (twice mean) | $2.11 Billion |
| 1.122% | (twice max) | $1.78 Billion |

This table shows that even if Detour-lake agreed to borrow the gold required for the Ghost-Path hedging technique at twice the maximum rate recorded in the historical data, they would still be guaranteed under all possible future gold price paths, to be approximately $1.8 billion better off, while also achieving their cost-of-capital/minimum-profit constraints and not adding any additional risk in the process. For comparison management's own risk-adjusted valuation of the Detour Lake project under their originally given financial assumptions was just $1.3 billion (after tax), so this risk-free $1.8 billion (pre-tax) profit enhancement would be in addition to that value. In addition, by facilitating the use of a lower cut-off grade, the new technique would prevent over 2.6 million ounces of gold from being irreversibly discarded and would result in almost a 50% increase in the life of the mine.

To understand the impact of the proposed new approach, note that the amount of gold physically produced by the mine in each time period tₖ is Qi (c⁰), and the amount borrowed Qₜ_{ₖ}(c^{α})−Qₜ_{ₖ}(c^{Ω}), combined this yields a total gold quantity for each time period tₖ>0 of Qₜ_{ₖ}(c^{α}), which is exactly what management originally deemed optimal given their forecasts of the future, cost-of-capital constraints, and risk preferences. The only difference is that in the new methodology the cost of implementing management's preferred strategy is paid in the form of lease payments, while in the standard cut-off approach the cost is paid in wasted gold. What this analysis shows is that wasting 2.6 million ounces of gold is an expensive way of modifying the timing of cash flows.

It is also important to note that under the new strategy and using this new customized lease agreement, the gold that otherwise would have been wasted (2.6 million ounces less the amount required to pay the future lease fees) would instead be borrowed initially at time t=0 and sold at the current spot price ($1638/ounce). A fraction of these proceeds would be then be placed in escrow in the form of risk-free bonds in an amount sufficient to fund the future value of the production costs of repaying this otherwise wasted amount of gold sometime in the future. These escrow funds along with the rights to the mine would ensure that the gold lender is always compensated in the event of the mine's default. The difference between the revenue from the time t=0 borrowed gold sale and the amounts placed in the escrow account, would be profit realized by the mine at time t=0 before production even begins. Hence the profit from the Ghost-Path technique could be tangibly realized by the mine instantly.

From the perspective of the gold investor(s), pension fund, gold ETF, central bank or national government that agrees to lend the gold in the lease agreement, one possible drawback is that this deal would require them to commit their gold to this process for a rather long period of time. If the investor had a long planning horizon this might not be significant, in general though this is a legitimate concern. However, under the extreme scenarios considered above this issue is completely moot. With lease rates as high as some of those considered here, if the gold lender ever wanted to get their gold back, they could just as easily borrow that gold from the market and be all but certain that their cost of borrowing will be far lower than the amounts that the mine is paying them for the same quantity of gold. Thus, what this shows is that the profit enhancements for the mine from this new approach are so large as to enable them to comfortably throw enough money at gold investors/lenders to counter all such possible considerations while still realizing a massive profit bonus for themselves.

In practice, a structured lease agreement such as the one suggested here would likely require some financial intermediary such as an investment bank to help facilitate the deal, and so there would likely be transaction costs associated with paying the fees charged by the intermediary. However, it is highly unlikely for such fees to be anywhere close to the $1.78-$2.45 billion profit enhancement that the new cut-off/hedging technique would provide.

Another important consideration is that the grade/tonnage histograms provided didn't include any cut-off values less than 0.3 g/t, even though the true optimal cut-off values must have been lower since under all scenarios, the lowest available cut-off in the data was always optimal. Presumably the data didn't include these cut-off ranges because present day cut-off theory precludes these values from ever being optimal and hence unworthy of consideration. What this means is that companies aren't currently focusing on the the right geological information when making their cut-off decisions. With more detailed geological information, perhaps even better results could have been achieved. Moreover, mine design architecture, phase planning, and investments in processing and extraction rate capabilities were all initially chosen by management to be optimal for a specific range of cut-off values that management believed would be used. Perhaps if these physical parameters were originally chosen to be optimized for the correct lower cut-off strategy paradigm proposed here, even greater results could be attained.

All cited publications are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

I. Arnsdorf. Morgan Stanley ship hauls frozen gas 14,500 miles to Tokyo. http:/www.bloomber.com/nws articles/2012-03-23/morgan-stanley-hired-ship-hauls-frozen-gas-14-500-miles-to-tokyo, 2012. Accessed on 2015 Apr. 29.
F. Black and M. Scholes. The pricing of options and corporate liabilities. The Journal of Political Economy, 81(3):637-654, 1973.
BBA. Mineral resource and mineral reserve update of the detour lake project. BBA Engineering, 2011.
A. Eydeland and K. Wolyniec. Energy and Power Risk Management. John Wiley and Sons, 2003.
J. C. Hull. Risk management and financial institutions. Wiley Finance, 3rd edition, 2012.
P. V. Johnson, G. W. Evatt, P. W. Duck, and S. D. Howell. The derivation and impact of an optimal cut-off grade regime upon mine valuations. Proceedings of the World Congress on Engineering, 1, 2010.
F. A. Longstaff and E. S. Schwartz. Valuing American options by simulation: A simple least-squares approach. Review of Financial Studies, 14(1):113-187, 2001.
J. E. Smith and R. F. Nau. Valuing risky projects: Options pricing theory and decision analysis. Management Science, 4(15):795-816, 1995.
M. Thompson, M. Nediak, Y. Levin. Optimal operations management and hedging in complete and partially complete markets. (under review 2017).
M. Thompson and D. Barr. Cut-off grade: A real options analysis. Resources Policy, 42:83-92, December 2014.

1. A method for improving an operating strategy of a physical operation, comprising:
obtaining a measure of at least one physical state variable that is produced, consumed, and/or processed by the physical operation;
using the measure of at least one physical state variable to determine first and second operating models for the physical operation;
implementing the first operating model in the physical operation such that the first operating model determines one or more of production, consumption, and processing of the physical state variable;
deriving a tool from the first and second operating models comprising a financial hedging strategy that is implemented in a financial market;
wherein the first operating model implemented in the physical operation together with the hedging strategy implemented in the financial market increase profitability of the physical operation.

2. The method of claim 1, wherein:
determining the first operating model maximizes a current market value of an asset;
deriving the tool comprises:
i) deriving delta hedging strategy based on the first operating model;
ii) using variables including the measure of at least one physical state variable to determine a second operating model comprising a ghost operating strategy, and a ghost hedging strategy;
iii) deriving a reverse delta-hedging strategy corresponding to a hypothetical contingent claim on the payoffs of the ghost operating strategy; and
iv) combining the delta hedging strategy, the ghost hedging strategy, and the reverse delta-hedging strategy to provide a combined hedging strategy;
wherein the combined hedging strategy is executed in a financial market.

3. The method of claim 2, wherein the first operating model includes forecasting asset value using a financial forward curve and using risk-free discount rates to adjust for risk and the time-value-of-money.

4. The method of claim 2, wherein the delta hedging strategy is derived from the first operating model under a risk-neutral probability measure or a partial risk-neutral probability measure for tradeable risk.

5. The method of claim 2, wherein the second operating model is optimized under a preferred objective/utility function including a true probability measure that incorporates forecasts for risk factors.

6. The method of claim 2, wherein the reverse-delta hedging strategy corresponds to a contingent-claim on payoffs of the second operating model.

7. The method of claim 6, wherein the reverse-delta hedging strategy synthetically replicates the changes in market value of a long position in a hypothetical contingent claim on the payoffs of the ghost-operating strategy determined using the second operating model.

8. The method of claim 1, wherein first operating model implemented in the physical operation together with the financial hedging strategy implemented in a financial market results in a higher utility relative to a utility expected according to current practice.

9. The method of claim 1, wherein the method is applied to a physical operation comprising commodity extraction.

10. The method of claim 9, wherein the commodity extraction is an industry selected from mining, forestry, oil, and gas.

11. The method of claim 9, wherein the physical state variable comprises an amount of a resource that remains to be extracted.

12. The method of claim 1, wherein the method is applied to a physical operation comprising commodity storage.

13. The method of claim 12, wherein the physical state variable comprises inventory level.

14. The method of claim 1, wherein the method is applied to a physical operation comprising electrical power generation.

15. The method of claim 14, wherein the physical state variable is selected from boiler temperature and time since a unit was activated/de-activated.

16. The method of claim 1, wherein the method is applied to a physical operation comprising shipping and transportation.

17. The method of claim 16, wherein the physical state variable comprises a location of a vessel.

18. A non-transitory computer-readable medium for optimizing an operations management strategy, comprising instructions stored thereon, that when executed on a processor, perform one or more of:
receiving a measure of at least one physical state variable that is produced, consumed, and/or processed by the physical operation;
using the measure of at least one physical state variable to determine first and second operating models for the physical operation;
deriving a tool from the first and second operating models comprising a financial hedging strategy that is implemented in a financial market;
wherein the first operating model implemented in the physical operation together with the hedging strategy implemented in the financial market increase profitability of the physical operation.

19. The non-transitory computer-readable medium of claim 17, wherein:
determining the first operating model maximizes a current market value of an asset;
deriving a tool comprises:
i) deriving delta hedging strategy based on the first operating model;
ii) using variables including the measure of at least one physical state variable to determine a second operating model comprising a ghost operating strategy, and a ghost hedging strategy;
iii) deriving a reverse delta-hedging strategy corresponding to a hypothetical contingent claim on the payoffs of the ghost operating strategy; and
iv) combining the delta hedging strategy, the ghost hedging strategy, and the reverse delta-hedging strategy to provide a combined hedging strategy.

20. The non-transitory computer-readable medium of claim 18, wherein the operations management strategy is applied to a physical operation comprising commodity extraction.

21. The non-transitory computer-readable medium of claim 20, wherein the commodity extraction is an industry selected from mining, forestry, oil, and gas.

22. The non-transitory computer-readable medium of claim 20, wherein the physical state variable comprises an amount of a resource that remains to be extracted.

23. The non-transitory computer-readable medium of claim 18, wherein the operations management strategy is applied to a physical operation comprising commodity storage.

24. The non-transitory computer-readable medium of claim 23, wherein the physical state variable comprises inventory level.

25. The non-transitory computer-readable medium of claim 18, wherein the operations management strategy is applied to a physical operation comprising electrical power generation.

26. The non-transitory computer-readable medium of claim 25, wherein the physical state variable is selected from boiler temperature and time since a unit was activated/de-activated.

27. The non-transitory computer-readable medium of claim 18, wherein the operations management strategy is applied to a physical operation comprising shipping and transportation.

28. The non-transitory computer-readable medium of claim 27, wherein the physical state variable comprises a location of a vessel.
